(19) United States
(12) Patent Application Publication
(10) Pub. No.: US 2018/0316620 A1
(43) Pub. Date: Nov. 1, 2018

(54) SERVICE FUNCTION PLACEMENT AND ROUTING

(71) Applicants: Jaime Llorca, Red Bank, NJ (US); Antonia Tulino, Red Bank, NJ (US)

(72) Inventors: Jaime Llorca, Red Bank, NJ (US); Antonia Tulino, Red Bank, NJ (US)

(73) Assignee: Alcatel-Lucent USA Inc., Murray Hill, NJ (US)

(21) Appl. No.: 15/581,362

(22) Filed: Apr. 28, 2017

(51) Int. Cl. H04L 12/911; H04L 29/08

(52) U.S. Cl. CPC H04L 47/70; H04L 67/10

(57) ABSTRACT

This disclosure generally discloses a service function virtualization capability configured to support virtualization of a service within a distributed cloud network. Various embodiments of the service function virtualization capability provide a set of fast approximation algorithms configured to solve the cloud service distribution problem in order to determine the placement of service functions of a service within a cloud network, the routing of service flows through the appropriate service functions of the service within the cloud network, and the associated allocation of cloud and network resources that satisfy client demands with reduced or even minimum overall cloud network cost in the distributed cloud network.

### TECHNICAL FIELD

The present disclosure relates generally to communication systems and, more specifically but not exclusively, to service function virtualization in communication systems.

### BACKGROUND

Distributed cloud networking builds on network function virtualization (NFV) and software defined networking (SDN) to enable the deployment of network services in the form of elastic virtual network functions (VNFs) that are instantiated over general purpose servers at distributed cloud locations and that are interconnected by a programmable network fabric.

### SUMMARY OF EMBODIMENTS

Various embodiments are configured to support service function virtualization in a distributed cloud network.

In at least some embodiments, an apparatus includes a processor and a memory communicatively connected to the processor. The processor is configured to determine a set of commodities for a service to be hosted within a cloud network for a set of client demands, where the service includes a set of service functions and the cloud network includes a set of cloud nodes and a set of network links. The processor is configured to, at each of a plurality of iterations, update, for each of the commodities at each of the cloud nodes based on the client demands, a respective set of queue variables for the respective commodity at the respective cloud nod and determine, based on the sets of queue variables of the respective commodities at the respective cloud nodes, a respective set of solution variables for the respective iteration. The processor is configured to determine, based on the respective sets of solution variables of at least a portion of the iterations, a service distribution solution for the service within the cloud network that is configured to satisfy the set of client demands. In at least some embodiments, a non-transitory computer-readable storage medium stores instructions which, when executed by a computer, cause the computer to perform a corresponding method. In at least some embodiments, a corresponding method may be provided.

In at least some embodiments, an apparatus includes a processor and a memory communicatively connected to the processor. The processor is configured to determine a set of commodities for a service to be hosted within a cloud network for a set of client demands where the service includes a set of service functions and the cloud network includes a set of cloud nodes and a set of network links. The processor is configured to define, for the cloud network based on a network graph of the cloud network, a cloud-augmented graph configured to track transport and processing of flows of the commodities at the cloud nodes. The processor is configured to define, for the cloud network, a cloud network queuing system including, for each of the commodities at each of the cloud nodes, a respective set of queue variables for the respective commodity at the respective cloud node. The processor is configured to determine, based on the cloud-augmented graph and the cloud network queuing system, a service distribution solution for the service within the cloud network that is configured to satisfy the set of client demands. In at least some embodiments, a non-transitory computer-readable storage medium stores instructions which, when executed by a computer, cause the computer to perform a corresponding method. In at least some embodiments, a corresponding method may be provided.

### BRIEF DESCRIPTION OF THE DRAWINGS

The teachings herein can be readily understood by considering the following detailed description in conjunction with the accompanying drawings, in which:

FIG. 1 depicts an exemplary distributed cloud system configured to support service function virtualization;

FIG. 2 depicts an embodiment of a method for configuring a distributed cloud network to support service function virtualization for a service;

FIG. 3 depicts an embodiment of a method for determining a distributed service solution for service function virtualization for a service;

FIG. 4 depicts an embodiment of a method for determining a distributed service solution for service function virtualization for a service;

FIG. 5 depicts an example of a multi-commodity-chain flow model for a service;

FIG. 6 depicts a portion of a cloud-augmented graph for a cloud node of a distributed cloud network;

FIG. 7 depicts an example network for use in evaluating performance of embodiments of service function virtualization;

FIGS. 8A-8C depict performance information for an embodiment of service function virtualization based on a simulation using the network of FIG. 7;

FIGS. 9A-9B depict performance information for an embodiment of service function virtualization based on a simulation using the network of FIG. 7; and

FIG. 10 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

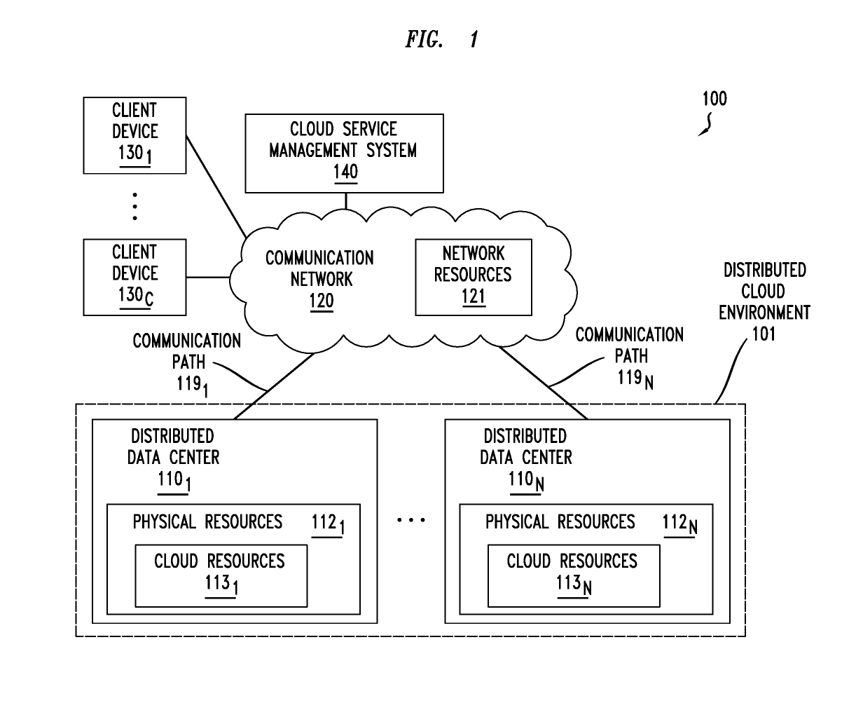

This disclosure generally discloses a service function virtualization capability configured to support virtualization of a service within a distributed cloud network. Various embodiments of the service function virtualization capability provide a set of fast approximation algorithms configured to solve the cloud service distribution problem in order to determine the placement of service functions of a service within a cloud network, the routing of service flows through the appropriate service functions of the service within the cloud network, and the associated allocation of cloud and network resources that satisfy client demands with reduced or even minimum overall cloud network cost in the distributed cloud network. The service may be a network service (e.g., distributed cloud networking within a distributed cloud network, which may build on network function virtualization (NFV) and software defined networking (SDN) to enable the deployment of network services in the form of elastic virtual network functions (VNFs) that are instantiated over general purpose servers at distributed cloud locations and that are interconnected by a programmable network fabric), a virtual reality service, an augmented reality service, of the like. Various embodiments of the service function virtualization capability may provide a fast fully polynomial time algorithm that provides a solution to the service distribution problem that is shown to be within an arbitrarily small factor, epsilon, of the optimal solution, in time proportional to 1/epsilon. These and various other embodiments and advantages of the service function virtualization capability may be further understood when considered within the context of an example of a distributed cloud system that is configured to support service function virtualization, as depicted in FIG. 1.

FIG. 1 depicts an exemplary distributed cloud system configured to support service function virtualization.

The distributed cloud system (DCS) 100 is configured to support distributed cloud networking based on NFV and SDN in order to enable the deployment of network services in the form of VNFs that are instantiated over general purpose servers at distributed cloud locations and interconnected by a programmable network fabric.

The DCS 100 includes a distributed cloud environment 101 having a set of distributed data centers (DDCs) 110₁-110_{N} (collectively, DDCs 110), a communication network (CN) 120, a set of client devices (CDs) 130₁-130_{C} (collectively, CDs 130), and a cloud service management system (CSMS) 140.

The DDCs 110 may be configured to support VNFs which may be instantiated within the DDCs 110 to support distributed cloud networking. The VNFs that are instantiated may depend on the type of communication network for which distributed cloud networking is being provided. For example, in the case of a Fourth Generation (4G) Evolved Packet Core (EPC) network, the VNFs may include virtualized Serving Gateways (SGWs), virtualized Packet Data Network (PDN) Gateways (PGWs), virtualized Mobility Management Entities (MMEs), or the like, as well as various combinations thereof. The DDCs 110 may include various types and configurations of resources, which may be used to support distributed cloud networking. The resources of the DDCs 110 may include various types and configurations of physical resources, which may be used to support various types and configurations of virtual resources. The DDCs 110₁-110_{D} may communicate with CN 120 via communication paths 119₁119_{D} (collectively, communication paths 119), respectively.

The DDCs 110 include respective sets of physical resources (PRs) 112₁-112_{D} (collectively, PRs 112) which may be used to support VNFs for distributed cloud networking. For example, PRs 112 of a DDC 110 may include computing resources, memory resources, storage resources, input-output (I/O) resources, networking resources, or the like. For example, PRs 112 of a DDC 110 may include servers, processor cores, memory devices, storage devices, networking devices (e.g., switches, routers, or the like), communication links, or the like, as well as various combinations thereof. For example, PRs 112 of a DDC 110 may include host servers configured to host virtual resources within the DDC 110 (e.g., including server blades organized in racks and connected via respective top-of-rack (TOR) switches, hypervisors, or the like), aggregating switches and routers configured to support communications of host servers within the DDC 110 (e.g., between host servers within the DDC 110, between host servers of the DDC 110 and devices located outside of the DDC 110, or the like), or the like, as well as various combinations thereof. The typical configuration and operation of PRs of a datacenter (e.g., such as PRs 112 of one or more of the DDCs 110) will be understood by one skilled in the art.

The PRs 112 of the DDCs 110 may be configured to support respective sets of cloud resources (CRs) 113₁113_{D} (collectively, CRs 113) which may be used to provide VNFs for distributed cloud networking. For example, CRs 113 supported using PRs 112 of a DDC 110 may include virtual computing resources, virtual memory resources, virtual storage resources, virtual networking resources (e.g., bandwidth), or the like, as well as various combinations thereof. The CRs 113 supported using PRs 112 of a DDC 110 may be provided in the form of virtual machines (VMs), virtual containers (VCs), virtual applications, virtual application instances, virtual file systems, or the like, as well as various combinations thereof. The allocation of CRs 113 of DDCs 110 may be performed by CSMS 140 based on solutions to the cloud network service distribution problem which may be determined by the CSMS 140 (e.g., based on determination of the placement of network service functions, based on determination of the routing of service flows through the appropriate network service functions, or the like, as well as various combinations thereof). It will be appreciated that the typical configuration and operation of VRs using PRs of a datacenter (e.g., such as configuration and operation of CRs 113 using PRs 112 of one or more of the DDCs 110) will be understood by one skilled in the art.

The DDCs 110 of cloud environment 101 may be arranged in various ways. The DDCs 110 may be located at any suitable geographic locations. The DDCs 110 (or at least a portion of the DDCs 110) may be distributed geographically. The DDCs 110 may be distributed across a geographic area of any suitable size (e.g., globally, on a particular continent, within a particular country, within a particular portion of a country, or the like). The DDCs 110 (or at least a portion of the DDCs 110) may be located relatively close to the end users. The DDCs 110 (or at least a portion of the DDCs 110) may be arranged hierarchically (e.g., with larger DDCs 110 having larger amounts of PRs 112 and CRs 113 being arranged closer to the top of the hierarchy (e.g., closer to a core network supporting communications by the larger DDCs 110) and smaller DDCs 110 having smaller amounts of PRs 112 and CRs 113 being arranged closer to the bottom of the hierarchy (e.g., closer to the end users). The DDCs 110 may be provided at existing locations (e.g., where the cloud provider may be a network service provider, at least a portion of the DDCs 110 may be implemented within Central Offices of the network service provider), standalone locations, or the like, as well as various combinations thereof. It will be appreciated that, although primarily presented with respect to an arrangement in which each of the DDCs 110 communicates via CN 120, communication between DDCs 110 may be provided in various other ways (e.g., via various communication networks or communication paths which may be available between DDCs 110). The DDCs 110 of cloud environment 101 may be arranged in various other ways.

The CN 120 may include any communication network(s) suitable for supporting communications within DCS 100 (e.g., between DDCs 110, between CDs 130 and DDCs 110, between CSMS 140 and DDCs 110, or the like). For example, CN 120 may include one or more wireline networks or one or more wireless networks, such as one or more of a Global System for Mobile (GSM) based network, a Code Divisional Multiple Access (CDMA) based network, a Long Term Evolution (LTE) based network, a Fifth Generation (5G) cellular network, a Local Area Network (LAN), a Wireless Local Area Network(s) (WLAN), a Metropolitan Area Network (MAN), a Wide Area Network (WAN), or the like. The CN 120 includes network resources 121 that may be configured to support communications within DCS 100, including support for communications associated with access and use of CRs 113 of DDCs 110 (e.g., between DDCs 110, between CDs 130 and DDCs 110, or the like) for accessing and using VNFs which may be provided by CRs 113. For example, network resources 121 may include network elements (e.g., data routing devices, control functions, or the like), communication links, or the like, as well as various combinations thereof.

The CDs 130 are client devices configured to communicate based on distributed cloud networking functions supported by the DDCs 110 of cloud environment 101 and based on the CN 120. The CDs 130 are client devices configured to communicate based on VNFs supported by the DDCs 110 of cloud environment 101 and based on network resources 121 supported by the CN 120. The CDs 130 may communicate via service flows which may be routed through VNFs supported by the DDCs 110 of the cloud environment 101. For example, the CDs 130 may be end user devices (e.g., smartphones, tablets, laptop computers, desktop computers, television set-top boxes (STBs), or the like), machine type communication (MTC) end devices (e.g., Internet-of-Things (IoT) devices or the like), network devices (e.g., gateways, servers, routers, or the like), or the like.

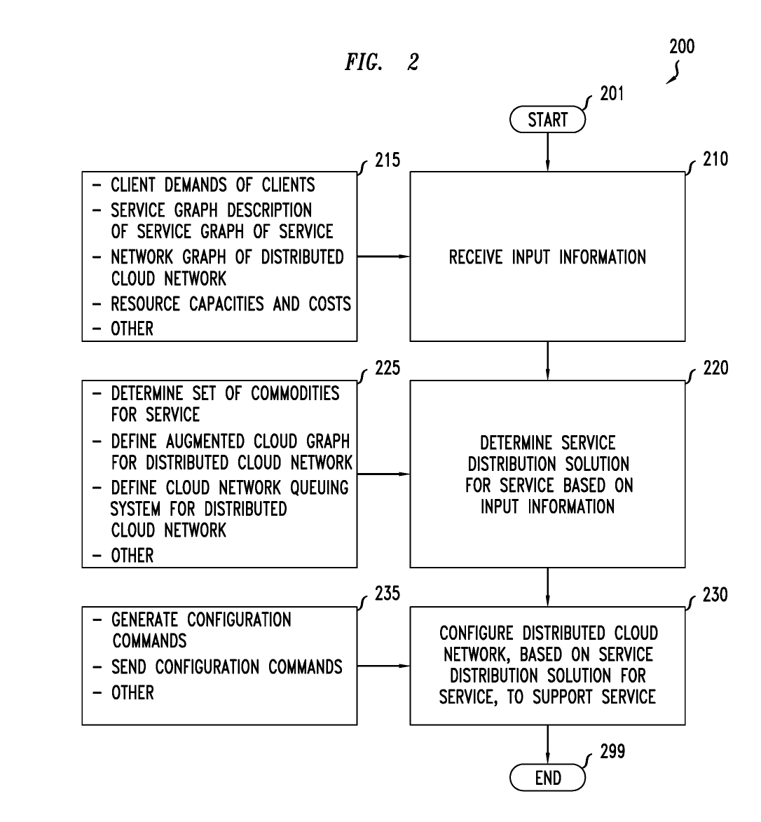

The CSMS 140 may be configured to support use of distributed cloud networking. The CSMS 140 may be configured to support a set of fast approximation algorithms configured to solve the cloud network service distribution problem in order to determine the placement of VNFs within the cloud environment 101 (e.g., the DDCs 110 at which the VNFs are to be placed, PRs 112 of the DDCs 110 at which the VNFs are to be placed, or the like, as well as various combinations thereof), the routing of service flows through the appropriate VNFs placed within the cloud environment 101, and the associated allocation of cloud resources (e.g., as CRs 113 of DDCs 110) and network resources (e.g., as network resources of DDCs 110 and network resources 121 of CN 120) that satisfy client demands of the CDs 130 with reduced or minimum overall cloud network cost. An example embodiment of a method by which CSMS 140 may provide such functions is presented with respect to FIG. 2. The CSMS 140 may be configured to perform various other functions in order to support use of distributed cloud networking.

FIG. 2 depicts an embodiment of a method for configuring a distributed cloud network to support service function virtualization for a service. It will be appreciated that, although primarily depicted and described as being performed serially, at least a portion of the functions of method 200 may be performed contemporaneously or in a different order than as presented in FIG. 2.

At block 201, method 200 begins.

At block 210, input information is received. As depicted in box 215, the input information may include a set of client demands of a set of clients, a service graph description of a service graph for the service, a network graph of the distributed cloud network, resource capacities and costs (e.g., for cloud resources, network resources, or the like), or the like, as well as various combinations thereof.

At block 220, a service distribution solution for the service is determined based on the input information.

The service distribution solution for the service may be determined based on the input information in various ways. The service distribution solution for the service may be determined based on processing of the input information. As indicated in box 225, the processing of the input information to determine the service distribution solution for the service may include determining a set of commodities for the service to be hosted within the distributed cloud network for the set of client demands, defining a cloud-augmented graph for the distributed cloud network, defining a cloud network queuing system for the distributed cloud network, or the like, as well as various combinations thereof.

The processing of the input information to determine the service distribution solution for the service may include determining a set of commodities for the service to be hosted within the distributed cloud network for the set of client. The set of commodities may be determined based on the set of client demands and based on the service graph description of the service graph of the service.

The processing of the input information to determine the service distribution solution for the service may include defining a cloud-augmented graph for the distributed cloud network. The cloud-augmented graph may be an augmented version of the cloud graph for the distributed cloud network, which includes cloud nodes and network links. The cloud nodes represent distributed cloud locations at which the service functions can be instantiated. The network links represent network connections between cloud locations. The cloud-augmented graph includes the cloud nodes, the network links, and, for each of the cloud nodes, a respective processing node representing flow processing functions at the cloud node, a source node representing a source unit via which flows enter the cloud network at the cloud node, and a demand node representing a demand unit via which flows exit the cloud network.

The processing of the input information to determine the service distribution solution for the service may include defining a cloud network queuing system for the distributed cloud network. The cloud network queuing system includes, for each of the commodities at each of the cloud nodes, a set of queue variables indicative of queueing of respective flows of the respective commodity at the respective cloud node.

The set of queue variables may include an actual queue variable. The set of queue variables may include an actual queue variable configured to be updated based on actual queuing dynamics of the respective commodity at the respective cloud node. The actual queuing dynamics may include arrival of flows of the respective commodity to the respective cloud node and departure of flows of the respective commodity from the respective cloud node. The actual queue variable for the respective commodity at the respective cloud node at a current iteration (t) may be updated based on the actual queue variable for the respective commodity at the respective cloud node at the previous iteration (t−1), arrival of flows of the respective commodity to the respective cloud node during the previous iteration (t−1), and departure of flows of the respective commodity from the respective cloud node during the previous iteration (t−1).

The set of queue variables may include a virtual queue variable. The set of queue variables may include a virtual queue variable configured to be updated based on a combination of actual queuing dynamics of the respective commodity at the respective cloud node and a differential queue backlog of the respective commodity at the respective cloud node over multiple iterations. The differential queue backlog of the respective commodity at the respective cloud node over multiple iterations may be based on a difference between virtual queue variables for the respective commodity at the respective cloud node in the previous iteration. The virtual queue variable for the respective commodity at the respective cloud node at a current iteration (t) may be updated based on the virtual queue variable for the respective commodity at the respective cloud node at the previous iteration (t−1), the actual queue variable for the respective commodity at the respective cloud node at the current iteration (t), the actual queue variable for the respective commodity at the respective cloud node at the previous iteration (t−1), and the differential queue backlog of the respective commodity at the respective cloud node over multiple iterations. The differential queue backlog of the respective commodity at the respective cloud node over multiple iterations may be based on the virtual queue variable for the respective commodity at the respective cloud node at the previous iteration (t−1) and the virtual queue variable for the respective commodity at the respective cloud node at the iteration (t−2) preceding the previous iteration (t−1). The service distribution solution for the service may be determined based on the cloud-augmented graph and the cloud network queuing system. The service distribution solution for the service within the distributed cloud network is configured to satisfy the set of client demands.

The service distribution solution for the service may be determined by, for each of the network links, selecting one of the commodities to transmit over the respective network link, allocating network resources on the respective network link for the selected one of the commodities, and assign respective flow rates for the commodities on the respective network link based on the selected one of the commodities. The one of the commodities to transmit over the respective network link may be selected by computing, for each of the commodities based on the respective sets of queue variables of the respective commodities, a respective transport utility weight of transmitting the respective commodity on the respective network link and then selecting the one of the commodities having a maximum respective transport utility weight. The allocation of network resources on the respective network link for the selected one of the commodities may include allocating network resources on the respective network link for the selected one of the commodities based on a capacity of the respective network link. The assignment of the respective flow rates for the commodities on the respective network link based on the selected one of the commodities may include assigning the respective flow rate for the selected one of the commodities based on the network resources allocated on the respective network link for the selected one of the commodities and based on a per-function resource requirement for the respective network link.

The service distribution solution for the service may be determined by, for each of the cloud nodes, selecting one of the commodities to be processed at the respective cloud node, allocating cloud resources on the respective cloud node for the selected one of the commodities, and assigning respective flow rates for the commodities based on the selected one of the commodities. The one of the commodities to be processed at the respective cloud node may be selected by computing, for each of the commodities based on the respective sets of queue variables of the respective commodities, a respective processing utility weight of processing the commodity at the cloud node and then selecting the one of the commodities having a maximum respective processing utility weight. The allocation of cloud resources on the respective cloud node for the selected one of the commodities may include allocating cloud resources on the respective cloud node for the selected one of the commodities based on a capacity of an edge between the respective cloud node and a respective processing node of a cloud-augmented graph including the cloud nodes. The assignment of the respective flow rates for the commodities based on the selected one of the commodities may include assigning the respective flow rate for the selected one of the commodities based on the cloud resources allocated on the respective cloud node for the selected one of the commodities and based on a per-function resource requirement for the respective cloud node.

The service distribution solution for the service may be determined by assigning flow rates for the commodities based on transport-related decisions made for each of the network links and based on processing-related decisions made for each of the cloud nodes and determining a flow solution for the service based on the flow rates assigned for the commodities.

The service distribution solution for the service may be determined by allocating network resources to the network links based on transport-related decisions made for each of the network links and determining a resource allocation solution for the service based on the network resources allocated to the network links.

The service distribution solution for the service may be determined by determining allocation of resources of the cloud network for satisfying the client demands. The allocation of resources of the cloud network for satisfying the client demands may be determined by determining for each of the cloud nodes an indication of an amount of processing resource units allocated at the respective cloud node for satisfying the client demands and determining for each of the network links an indication of an amount of transport resource units allocated at the respective network links for satisfying the client demands.

The service distribution solution for the service may be determined by performing transport-related decisions for each of the network links, performing processing-related decisions for each of the cloud nodes, and determining the service distribution solution based on the transport-related decisions and the processing-related decisions. The transport-related decisions may include, for each of the network links, allocating available transmission resource units to transmit over the respective network link one of the commodities having a maximum transport utility weight. The processing-related decisions may include, for each of the cloud nodes, allocating available processing resource units of the respective cloud node to process at the respective cloud node one of the commodities having a maximum processing utility weight. The service distribution solution may include at least one of a flow solution or a resource allocation solution.

The service distribution solution for the service may be specified in various ways.

The service distribution solution may include an indication of a placement of the service functions of the service within the distributed cloud network. The placement of the service functions of the service within the distributed cloud network may include an indication, for each of the service functions, of one of the cloud nodes at which the respective service function is placed.

The service distribution solution may include an indication of routing of service flows of the client demands through the service functions of the service. The indication of the routing of the service flows of the client demands through the service functions of the service may include an indication of an amount of flow of each commodity processed at each of the cloud nodes and routed through each of the network links.

The service distribution solution may include (1) for each of the cloud nodes, an indication of an amount of processing resource units allocated at the respective cloud node for satisfying the client demands and (2) for each of the network links, an indication of an amount of transport resource units allocated at the respective network links for satisfying the client demands.

At block 230, the distributed cloud network is configured, based on the service distribution solution for the service, to support the service. As indicated by box 235, the distributed cloud network may be configured, to support the service based on the service distribution solution for the service, by generating configuration commands based on the service distribution solution and sending the configuration commands to the distributed cloud network to configure the distributed cloud network to support the service. The configuration commands may be generated for and sent to cloud nodes of the distributed cloud network to configure the cloud nodes and associated network links to allocate resources to support the service based on the service distribution solution for the service.

At block 299, method 200 ends.

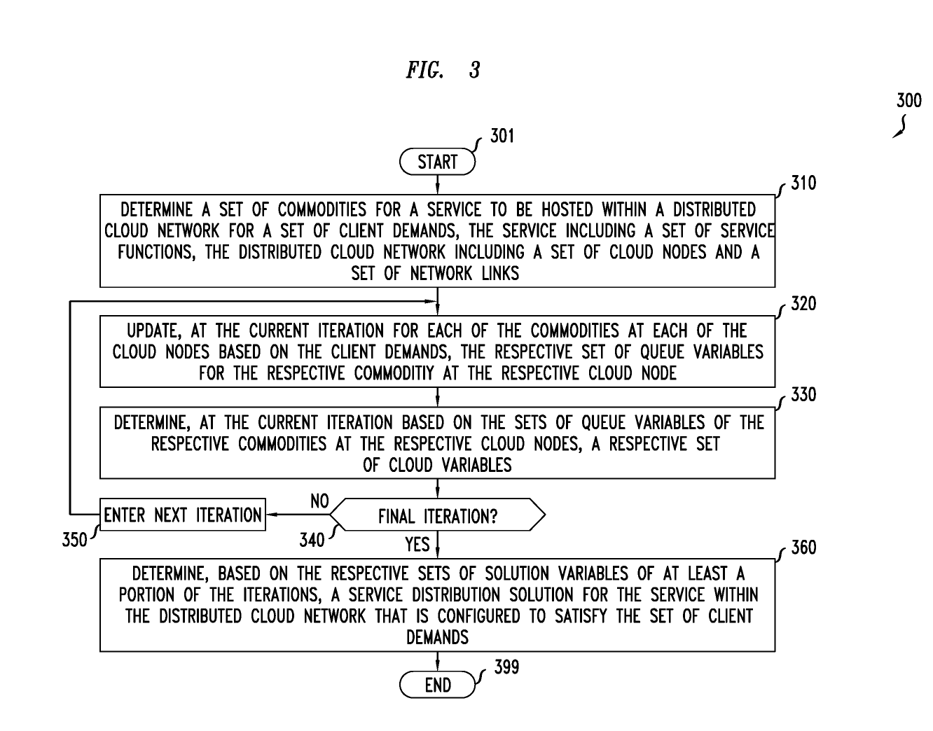

FIG. 3 depicts an embodiment of a method for determining a distributed service solution for service function virtualization for a service. The method 300 may be used to provide block 220 of FIG. 2. It will be appreciated that, although primarily depicted and described as being performed serially, at least a portion of the functions of method 300 may be performed contemporaneously or in a different order than as presented in FIG. 3.

At block 301, method 300 begins.

At block 310, a set of commodities for a service to be hosted within a distributed cloud network for a set of client demands is determined. The service includes a set of service functions. The distributed cloud network includes a set of cloud nodes and a set of network links. It is noted that, from block 310, method 300 enters an iterative process in which blocks 320 and 330 are performed for each of a plurality of iterations.

At block 320, at the current iteration, for each of the commodities at each of the cloud nodes, a respective set of queue variables for the respective commodity at the respective cloud node is updated based on the client demands.

At block 330, at the current iteration, a respective set of solution variables is determined based on the sets of queue variables of the respective commodities at the respective cloud nodes.

At block 340, a determination is made as to whether the current iteration is the final iteration to be performed. If the current iteration is not the final iteration to be performed, method 300 proceeds to block 350. If the current iteration is the final iteration to be performed, method 300 proceeds to block 360.

At block 350, the next iteration is entered (becoming the current iteration). From block 350, method 300 returns to block 320 such that the iterative updating of queue variables and determination of solution variables may be performed for the next iteration.

At block 360, the service distribution solution for the service within the distributed cloud network is determined, based on the respective sets of solution variables of at least a portion of the iterations, where the service distribution solution for the service is configured to satisfy the set of client demands. From block 360, method 300 proceeds to block 399 (where method 300 ends).

At block 399, method 300 ends.

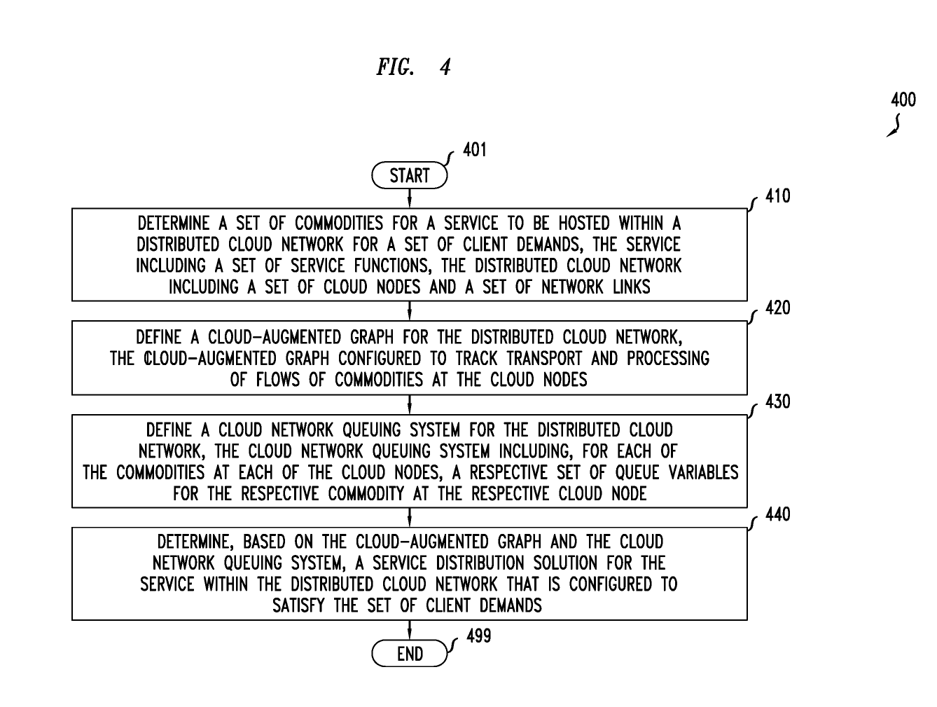

FIG. 4 depicts an embodiment of a method for determining a distributed service solution for service function virtualization for a service. The method 400 may be used to provide block 220 of FIG. 2. It will be appreciated that, although primarily depicted and described as being performed serially, at least a portion of the functions of method 400 may be performed contemporaneously or in a different order than as presented in FIG. 4.

At block 401, method 400 begins.

At block 410, determine a set of commodities for a service to be hosted within a distributed cloud network for a set of client demands. The service includes a set of service functions. The distributed cloud network includes a set of cloud nodes and a set of network links.

At block 420, define a cloud-augmented graph for the distributed cloud network. The cloud-augmented graph is configured to track transport and processing of flows of the commodities at the cloud nodes. The cloud-augmented graph may be a modified version of the cloud graph of the distributed cloud network (which includes the cloud nodes and network links of the distributed cloud network) that has been augmented to support tracking of the transport and processing of the flows of the commodities at the cloud nodes (by including, for each of the cloud nodes, a respective processing node representing flow processing functions at the cloud node, a source node representing a source unit via which flows enter the distributed cloud network at the cloud node, and a demand node representing a demand unit via which flows exit the distributed cloud network).

At block 430, define a cloud network queuing system for the distributed cloud network. The cloud network queuing system includes, for each of the commodities at each of the cloud nodes, a respective set of queue variables for the respective commodity at the respective cloud node.

At block 440, determine, based on the cloud-augmented graph and the cloud network queuing system, a service distribution solution for the service within the distributed cloud network that is configured to satisfy the set of client demands.

At block 499, method 400 ends.

Various embodiments of the distributed cloud networking capability for supporting distributed cloud networking may be configured to solve a cloud network service distribution problem in order to determine the placement of network service functions, the routing of service flows through the appropriate network service functions, and the associated allocation of cloud and network resources that satisfy client demands with reduced or even minimum overall cloud network cost in the distributed cloud network.

Various embodiments of the distributed cloud networking capability may be further understood by considering a more formal definition and description of distributed cloud networking, which follows.

As discussed hereinabove, distributed cloud networking builds on NFV and SDN to enable the deployment of network services in the form of elastic VNFs instantiated over general purpose servers at distributed cloud locations that are interconnected by a programmable network fabric that allows dynamic steering of client flows. A cloud network operator can then host a variety of services over a common physical infrastructure, reducing both capital and operational expenses. In order to make the most of this attractive scenario, a key challenge is to find the placement of VNFs and the routing of client flows through the appropriate VNFs that minimize the use of the physical infrastructure.

Various embodiments of the distributed cloud networking capability provide fast approximation algorithms for the NFV service distribution problem (NSDP), whose goal is to determine the placement of VNFs (which also may account for service chaining), the routing of service flows (which also may include support for flow routing optimization), and the associated allocation of cloud and network resources that satisfy client demands with minimum cost.

In various embodiments of the distributed cloud networking capability, the NSDP may be formulated as a minimum cost multi-commodity-chain network design (MCCND) problem on a cloud-augmented graph, where the goal is to find the placement of service functions, the routing of client flows through the appropriate service functions, and the corresponding allocation of cloud and network resources that minimize the cloud network operational cost.

In various embodiments of the distributed cloud networking capability, in the case of load-proportional costs, the resulting fractional NSDP can be formulated as a min-cost multi-commodity-chain flow (MCCF) problem that admits optimal polynomial-time solutions. The resulting fractional NSDP can be formulated as a multi-commodity-chain flow problem on a cloud-augmented graph and a queue-length based algorithm, denoted herein as queue-length based NFV service distribution (QNSD), may be used to provide an O(ε) approximation to the fractional NSDP in time O(1/ε). In various embodiments, the QNSD exhibits an improved O(1/\sqrt{ε}) convergence.

In various embodiments of the distributed cloud networking capability, QNSD also may be configured to handle the case in which resource costs are a function of the integer number of allocated resources, in which case the QNSD may be configured to effectively push for flow consolidation into a limited number of active resources to minimize overall cloud network cost. This version of the algorithm may be referred to herein as C-QNSD, which is configured to constrain the evolution of QNSD to effectively drive service flows to consolidate on a limited number of active resources, yielding good practical solutions to the integer NSDP.

Various embodiments of the distributed cloud networking capability may be further understood by considering the following system model.

Various embodiments of the distributed cloud networking capability may be further understood by considering the following cloud network model. The cloud network is modeled as a directed graph G=(V,E) with n=|V| vertices and m=|E| edges representing the set of nodes and links, respectively. A cloud network node represents a distributed cloud location, in which virtual network functions or VNFs can be instantiated in the form of e.g. virtual machines (VMs) over general purpose servers. When service flows go through VNFs at a cloud node, they consume cloud resources (e.g., CPU, memory, input-output, and the like). The cost per cloud resource unit (e.g., server) at node u is denoted by wᵤ and the maximum number of cloud resource units that can be allocated at node u is denoted by cᵤ. A cloud network link represents a network connection between two cloud locations. When service flows go through a cloud network link, the service flows consume network resources (e.g., bandwidth). The cost per network resource unit (e.g., 1 Gbps link) on link (u,v) is denoted by wᵤᵥ, and maximum number of network resource units that can be allocated on link (u,v) is denoted by cᵤᵥ.

Various embodiments of the distributed cloud networking capability may be further understood by considering the following service model.

A service ϕ∈Φ is described by a chain of M₉₉ VNFs. The pair (ϕ,i), with ϕ∈Φ,i∈{1 , . . . , M₉₉ } is used to denote the i-th function of service ϕ, and L is used to denote the total number of available VNFs. Each VNF is characterized by its cloud resource requirement, which may also depend on the specific cloud location. The cloud resource requirement (in cloud resource units per flow unit) of function (ϕ,i) at cloud node u is denoted by rᵤ^{(ϕ,i)}. That is, when one flow unit goes through function (ϕ,i) at cloud node u, it consumes rᵤ^{(ϕ,i)} cloud resource units. In addition, when one flow unit goes through the fundamental transport function of link (u,v), it consumes rᵤᵥ^{tr}, network resource units.

A client requesting service ϕ∈Φ is represented by a destination node d∈D(ϕ)⊂V, where D(ϕ) denotes the set of clients requesting service ϕ. T he demand of client d for service ϕ is described by a set of source nodes S(d,ϕ)∈V and demands λₛ^{d,ϕ}, ∀S∈S(d,ϕ), indicating that a set of source flows, each of size λₛ^{d,ϕ} flow units and entering the network at s∈S(d,ϕ), must go through the sequence of VNFs of service ϕ before exiting the network at destination node d∈D(ϕ). λᵤ^{(d,ϕ)}=0, ∀u∉S(d,ϕ) indicates that only nodes in S(d,ϕ) have source flows for the request of client d for service ϕ. It is noted that the adopted destination-based client model allows the total number of clients to scale linearly with the size of the network, as opposed to the quadratic scaling of the source-destination client model.

Various embodiments of the distributed cloud networking capability may be further understood by considering a more formal definition of the NFV service distribution problem.

In general, the goal of the NFV service distribution problem (NSDP) is to find the placement of service functions, the routing of service flows, and the associated allocation of cloud and network resources, that meet client demands with minimum overall resource cost. In various embodiments, the NSDP can be solved by computing a chained network flow on a properly constructed graph.

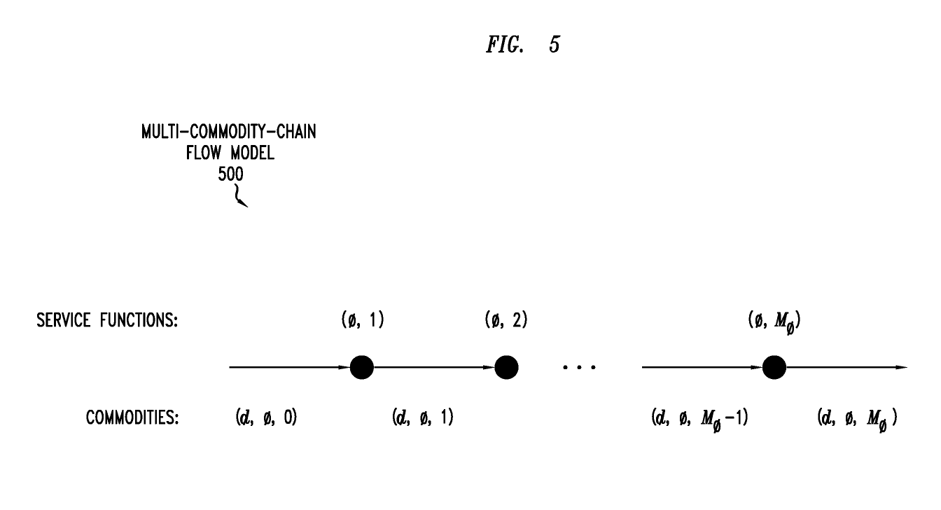

A multi-commodity-chain flow (MCCF) model is adopted. In the MCCF model, a commodity is uniquely identified by the triplet (d,ϕ,i), which indicates that commodity (d,ϕ,i) is the output of the i-th function of service ϕ for client d. This is illustrated in FIG. 5. As depicted in FIG. 5, for the multi-commodity-chain flow model 500, service ϕ for destination d takes source commodity (d,ϕ,0) and processes it via function (ϕ,1) to create commodity (d,ϕ,1), which is then processed by function (ϕ,2) and so forth, until function (ϕ,M_{ϕ}) produces final commodity (d,ϕ,M_{ϕ})

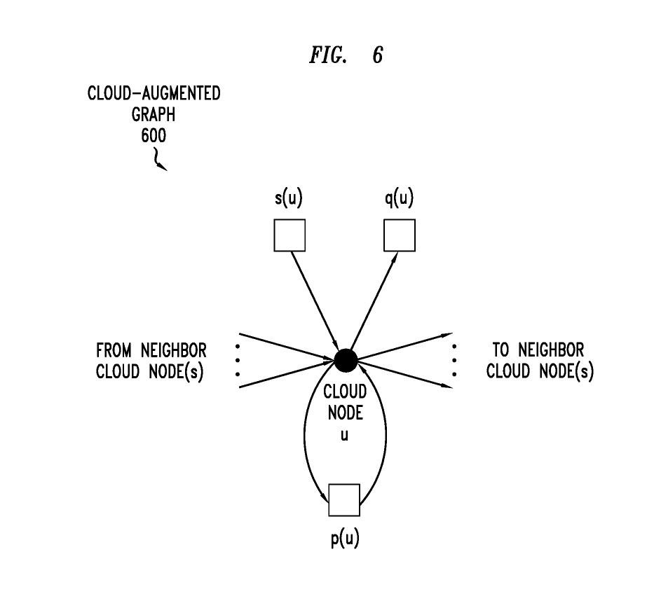

The NSDP is formulated as a MCCF problem on the cloud-augmented graph that results from augmenting each cloud node u in G with additional nodes representing the processing unit (denoted as p(u)), source unit (denoted as s(u), and demand unit (denoted as q(u)) at cloud node u and with (2) additional edges connecting the additional nodes to the cloud node u. The resulting graph is denoted by G^{a}=(V^{a},E^{a}), with V^{a}=V∪V′, E^{a}=E∪E′, and where V′ and E′ denote the set of processing, source, and demand unit nodes and edges, respectively. The set of incoming and outgoing neighbors of node u in G^{a} are denoted by δ⁻(u) and δ⁺(u). This is illustrated in FIG. 6. As depicted in FIG. 6, the cloud-augmented network graph 600 for cloud node u including a node p(u) which represents the processing unit that hosts flow processing functions, a node s(u) which represents the source unit from which flows enter the cloud network, and a node q(u) which represents the demand unit via which flows exit the cloud network.

In the cloud-augmented graph G^{a}, each edge (u,v)∈E^{a} has an associated capacity, unit resource cost, and per-function resource requirement, as described in the following.

For the set of edges {(u,p(u)), (p(u),u):u∈V} representing the set of compute resources:

c_{u,p(u)}=Cᵤ, c_{p(u),u}=cᵤ^{max}

w_{u,p(u)}=wᵤ, w_{p(u),u}=0

r_{u,p(u)}^{(ϕ,i)}=rᵤ^{(ϕ,i)}, ∀(ϕ,i)

where cᵤ^{max}=Σ_{(d,ϕ,i)}Σ_{s∈S(d,ϕ)}λₛ^{(d,ϕ)}rᵤ^{(ϕ,i)}. It is noted that the processing of network flows and associated allocation of compute resources is modeled using link (u, p(u)), edge (p(u),u) is a free-cost edge of sufficiently high capacity that carries the processed flow back to node u.

For the set of edges {(s(u),u),(u,q(u)):u∈V} representing the resources via which client flows enter and exit the cloud network:

c_{s(u),u}=cᵤ^{max}, c_{u,q(u)}=Cᵤ^{max}

wₛ₍ᵤ₎ᵤ=0, w_{u,q(u)}=0

rₛ₍ᵤ₎ᵤ^{(ϕ,i)}=r_{u,q(u)}^{(ϕ,i)}=0, ∀(ϕ,i).

It is noted that the ingress and egress of network flows are modeled via free-cost edges of sufficiently high capacity. In addition, the irrelevant per-function resource requirement for these edges is set to zero.

Given that the set of network resources only perform the fundamental transport function of moving bits between cloud network nodes, the per-function resource requirement for the set of edges in the original graph (u,v)∈E is set to rᵤᵥ^{tr} for all (ϕ,i), i.e., rᵤᵥ^{(ϕ,i)}=rᵤᵥ^{tr}, ∀(ϕ,i). The capacity and unit resource cost of network edge (u,v)∈E is given by cᵤᵥ, and wᵤᵥ, respectively.

The following MCCF flow and resource allocation variables on the cloud-augmented graph G^{a} are defined as follows.

Flow variables: fᵤᵥ^{(d,ϕ,i)} indicates the fraction of commodity (d,ϕ,i) on edge (u,v)∈E^{a}, i.e., the fraction of flow output of function (ϕ,i) for destination d carried/processed by edge (u,v).

Resource variables: yᵤᵥ indicates the total amount of resource units (e.g., cloud or network resource units) allocated on edge (u,v)∈E^{a}.

The NSDP can then be formulated via the following compact linear program:

$$\begin{matrix}min {\sum }_{( u , v ) ∈ {𝔼}^{a}} {w}_{uv} {y}_{uv} & ( 1 ) \\ s . t . {\sum }_{v ∈ {δ}^{-} ( u )} {f}_{vu}^{( d , φ , i )} = {\sum }_{v ∈ {δ}^{+} ( u )} {f}_{uv}^{( d , φ , i )} ∀ u , d , φ , i & ( 2 ) \\ {f}_{p ( u ) , u}^{( d , φ , i )} = {f}_{u , p ( u )}^{( d , φ , i - 1 )} ∀ u , d , φ , i \neq 0 & ( 3 ) \\ {\sum }_{( d , φ , i )} {f}_{uv}^{( d , φ , i )} {r}_{uv}^{( φ , i + 1 )} \leq {y}_{uv} \leq {c}_{uv} ∀ ( u , v ) & ( 4 ) \\ {f}_{s ( u ) , u}^{( d , φ , 0 )} = {λ}_{u}^{( d , φ )} ∀ u , d , φ & ( 5 ) \\ {f}_{u , q ( u )}^{( d , φ , {M}_{φ} )} = 0 d , φ , u \neq d & ( 6 ) \\ {f}_{uv}^{( d , φ , i )} \geq 0 , {y}_{uv} ∈ {Z}^{+} ∀ ( u , v ) , d , φ , i & ( 7 )\end{matrix}$$

where, when not specified for compactness, u∈V, d∈V, ϕ∈Φ, i ∈{1, . . . , M_{ϕ}}, and (u,v)∈E^{a}.

The objective is to minimize the overall cloud network resource cost, described by Eq. (1). Recall that the set E^{a} contains all edges in the augmented graph G^{a}, representing both cloud resource and network resources. Eq. (2) describes standard flow conservation constraints applied to all nodes in V. A critical set of constraints is the service chaining constraints described by Eq. (3), as these constraints establish that, in order to have flow of a given commodity (d,ϕ,i) coming out of a processing unit, the input commodity (d,ϕ,i−1) must be entering the processing unit. The constraints of Eq. (4) ensure that the total flow at a given cloud network resource is covered by enough resource units without violating capacity (recall from the MCCF model that commodity (d, 0, i) gets processed by function (ϕ,i+1) and that rᵤᵥ^{tr}, ∀(u,v)∈E,ϕ,i). Eqs. (5) and (6) establish the source and demand constraints. It is noted that, from Eq. (6), no flows of final commodity (d,ϕ,M_{ϕ}) are allowed to exit the network other than at the destination node d. Finally, Eq. (7) describes the fractional and integer nature of flow and resource allocation variables, respectively.

In this description, is is assumed that fractional flow variables are being used (e.g., in order to capture the ability to split client flows to improve overall cloud network resource utilization). With respect to the resource allocation variables, however, the following two versions of the NSDP (Fractional NSDP and Integer NSDP) are discussed further below.

Fractional NSDP: The use of fractional resource variables becomes a good compromise between accuracy and tractability when the size of the cloud network resource units is much smaller than the total flow served at a given location. This is indeed the case for services that serve a large number of large-size flows (e.g., telco services) and/or services deployed using small-size resource units (e.g., micro-services). In this case, the NSDP becomes a generalization of min-cost MCF, with the exact equivalence holding in the case of single commodity services. The resulting MCCF problem is referred to herein as the fractional NSDP.

Integer NSDP: The use of integer resource variables allows for accurately capturing the allocation of an integer number of general purpose resource units (e.g., servers). In this case, the NSDP becomes a generalization of multi-commodity network design (MCND), where the network is augmented with compute edges that model the processing of service flows and where there are additional service chaining constraints that make sure flows follow service functions in the appropriate order. In fact, for the special case that each service is composed of a single commodity, the NSDP is equivalent to the MCND. The resulting MCCND problem is referred to herein as the integer NSDP.

Various embodiments of the distributed cloud networking capability may be configured to support fractional NSDP.

As discussed above, the fractional NSDP can be formulated as the MCCF problem that results from the linear relaxation of Eq. (2), i.e., by replacing yᵤᵥ∈Z′ with yᵤᵥ≥0 in Eq. (7). While the resulting linear programming formulation admits optimal polynomial-time solutions, it requires solving a linear program with a large number of constraints. Here, a goal is to define a fast fully polynomial approximation scheme (FPTAS) for the fractional NSDP. More specifically, a goal is to target the design of faster approximations with order improvements in running time, i.e., O(1/ε) and O(1/\sqrt{ε}), using queue-length based algorithms, in order to construct fast iterative algorithms for static MCCF problems such as the fractional NSDP (providing an improvement over approaches in which shortest-path computations are used, since such techniques have only been shown to provide O(ε) approximations in time O(1/ε²).

Various embodiments of the distributed cloud networking capability may be configured to support fractional NSDP using the QNSD algorithm. In general, QNSD is an iterative algorithm that mimics the time evolution of an underlying cloud network queueing system. In general, QNSD may exhibit the following main key features: (1) QNSD uses the average over the algorithm iterations to compute the solution to the fractional NSDP and (2) QNSD computes the solution to the fractional NSDP by averaging over a limited iteration horizon, yielding an O(ε) approximation in time O(1/∃). In the QNSD algorithm description, j∈Z⁺ is used to index the iteration frame over which averages are computed. Additionally, QNSD may be configured to further exploit the speed-up shown in gradient methods for convex optimization when combining gradient directions over consecutive iterations, thereby leading to a conjectured O(1/\sqrt{ε}) convergence.

The QNSD is a queue-based algorithm that may be based on various queue variables (e.g., actual queue variables, virtual queue variables, or the like, as well as various combinations thereof).

Actual queue variables: Qᵤ^{(d,ϕ,i)}(t) denotes the queue backlog of commodity (d,ϕ,i) at node u∈V in iteration t. These actual queue variables represent the actual packet build-up that would take place in an equivalent dynamic cloud network system in which iterations correspond to time instants.

Virtual queue variables: Uᵤ^{(d,ϕ,i)}(t) denotes the virtual queue backlog of commodity (d,ϕ,i) at node u∈V in iteration t. These virtual queue variables are used to capture the momentum generated when combining differential queue backlogs (acting as gradients in our algorithm) over consecutive iterations.

The QNSD algorithm may operate as follows, including an initialization phase and a main procedure.

In the initialization phase of the QNSD algorithm, the following variables are initizlied:

$${f}_{uv}^{( d , φ , i )} ( 0 ) = {y}_{uv} ( 0 ) = 0 ∀ ( u , v )$$

$${Q}_{u}^{( d , φ , i )} ( 0 ) = 0 ∀ ( u , v ) , d , φ , i$$

$${Q}_{d}^{( d , φ , {M}_{φ} )} ( t ) = 0 ∀ d , φ , t$$

$${U}_{u}^{( d , φ , i )} ( 0 ) = {U}_{u}^{( d , φ , i )} ( - 1 ) = 0 ∀ u , d , φ , i$$

$${U}_{d}^{( d , φ , {M}_{φ} )} ( t ) = 0 ∀ d , φ , i , t$$

$${f}_{s ( u ) , u}^{( d , φ , i )} ( t ) = \{ \begin{matrix}{λ}_{u}^{( d , φ )} & ∀ u ∈ S ( d , φ ) , i = 0 , t \\ 0 & otherwise\end{matrix} \\ j = 0$$

It is noted that the queues associated with the final commodities at their respective destinations are set to zero for all t to model the egress of flows from the cloud network.

In the main procedure of the QNSD algorithm, the a number of steps are performed in each iteration t>0 , including queue variable updates, transport decisions made based on the queue variable updates, processing decisions made based on the queue variable updates, and construction of a solution based on the transport decisions and the processing decisions.

In the main procedure of the QNSD algorithm, the queue variable updates may be performed as follows:

For all (d,ϕ,i)≠(u,ϕ,M_{ϕ}):

$$\begin{matrix}{Q}_{u}^{( d , φ , i )} ( t ) = {[ {Q}_{u}^{( d , φ , i )} ( t - 1 ) - {\sum }_{v ∈ {δ}^{+} ( u )} {f}_{uv}^{( d , φ , i )} ( t - 1 ) + {\sum }_{v ∈ {δ}^{-} ( u )} {f}_{vu}^{( d , φ , i )} ( t - 1 ) ]}^{+} & ( 8 ) \\ Δ {Q}_{uv}^{( d , φ , i )} ( t ) = {Q}_{u}^{( d , φ , i )} ( t ) - {Q}_{u}^{( d , φ , i )} ( t - 1 ) & ( 9 ) \\ {U}_{u}^{( d , φ , i )} ( t ) = {U}_{u}^{( d , φ , i )} ( t - 1 ) + Δ {Q}_{uv}^{( d , φ , i )} ( t ) + θ ( {U}_{u}^{( d , φ , i )} ( t - 1 ) - {U}_{u}^{( d , φ , i )} ( t - 2 ) ) & ( 10 )\end{matrix}$$

where θ∈[0,1) is a control parameter that drives the differential queue backlog momentum. It is noted that actual queues are updated according to standard queuing dynamics (e.g., based on packets that arrive from a neighbor cloud node and packets that are output to a neighbor cloud node), while virtual queues are updated based on a combination of the actual differential queue backlog and the virtual differential queue backlog in the previous iteration.

In the main procedure of the QNSD algorithm, transport decisions may be performed by, for each link (u,v)∈E, computing the transport utility weight of each commodity (d,ϕ,i), computing the max-weight commodity (d,ϕ,i)*, and allocating network resources and assigning flow rates.

The transport utility weight of each commodity (d,ϕ,i) may be computed as:

$${W}_{uv}^{( d , φ , i )} ( t ) = \frac{1}{{r}_{uv}^{tr}} ( {U}_{u}^{( d , φ , i )} ( t ) - {U}_{v}^{( d , φ , i )} ( t ) )$$

where V is a control parameter that governs the tradeoff between optimality and running-time.

The max-weight commodity (d,ϕ,i)* may be computed as:

$${( d , φ , i )}^{*} = {arg max}_{( d , φ , i )} \{ {W}_{uv}^{( d , φ , i )} ( t ) \} .$$

The allocation of network resources and assignment of flow rates may be performed as:

$${y}_{uv} ( t ) = \{ \begin{matrix}{c}_{uv} & if {W}_{uv}^{( d , φ , i )} ( t ) - {Vw}_{uv} > 0 \\ o & otherwise\end{matrix} \\ {f}_{uv}^{{( d , φ , i )}^{*}} = {y}_{uv} / {r}_{uv}^{tr} \\ {f}_{uv}^{( d , φ , i )} ( t ) = 0 , ∀ ( d , φ , i ) \neq {( d , φ , i )}^{*} .$$

In the main procedure of the QNSD algorithm, processing decisions may be performed by, for each node u∈V, computing the processing utility weight of each commodity (d,ϕ,i), computing the max-weight commodity (d,ϕ,i)*, and allocating cloud resources and assigning flow rates.

The processing utility weight of each commodity (d,ϕ,i) may be computed as:

$${W}_{u}^{( d , φ , i )} ( t ) = \frac{1}{{r}_{u}^{( φ , i + 1 )}} ( {U}_{u}^{( d , φ , i )} ( t ) - {U}_{u}^{( d , φ , i + 1 )} ( t ) ) ,$$

where this step in the QNSD computes the benefit of processing commodity (d,ϕ,i) via function (ϕ,i+1) at node u in iteration t, taking into account the difference between the (virtual) queue backlog of commodity (d,ϕ,i) and that of the next commodity in the service chain (d,ϕ,i+1). It is noted that a high cloud resource requirement rᵤ^{ϕ,i+1)} reduces the benefit of processing commodity (d,ϕ,i).

The max-weight commodity (d,ϕ,i)* may be computed as:

$${( d , φ , i )}^{*} = {arg max}_{( d , φ , i )} \{ {W}_{uv}^{( d , φ , i )} ( t ) \}$$

The allocation of cloud resources and assignment of flow rates may be performed as:

$${y}_{u , p ( u )} ( t ) = \{ \begin{matrix}{c}_{u} & if {W}_{uv}^{( d , φ , i )} ( t ) - {Vw}_{uv} > 0 \\ 0 & otherwise\end{matrix} \\ {y}_{p ( u ) , u} = {y}_{u , p ( u )} \\ {f}_{u , p ( u )}^{{( d , φ , i )}^{*}} ( t ) = {y}_{u , p ( u )} / {r}_{u}^{( φ , i + 1 )} \\ {f}_{p ( u ) , u}^{{( d , φ , i + 1 )}^{*}} ( t ) = {f}_{u , p ( u )}^{{( d , φ , i )}^{*}} ( t ) \\ {f}_{u , p ( u )}^{( d , φ , i )} ( t ) = {f}_{p ( u ) , u}^{( d , φ , i )} ( t ) = 0 ∀ ( d , φ , i ) \neq {( d , φ , u )}^{*}$$

In the main procedure of the QNSD algorithm, the solution may be constructed based on the transport-related decision and the processing-related decision as discussed above. The solution may include a flow solution and a resource allocation solution. The solution may be constructed as follows. The solution may be constructed based on variables in which, if t=2^{j}, then tₛₜₐᵣₜ=t and j=j+1.

The flow solution may be constructed based on:

$${\overline{f}}_{uv}^{( d , φ , i )} = \frac{{\sum }_{τ = {t}_{start}}^{t} {f}_{uv}^{( d , φ , i} ( τ )}{t - {t}_{start} + 1} ∀ ( u , v ) , d , φ , i \qquad ( 11 )$$

The resource allocation solution may be constructed based on:

$${\overline{y}}_{uv} = \frac{{\sum }_{τ = {t}_{start}}^{t} {y}_{uv} ( τ )}{t - {t}_{start} + 1} ∀ ( u , v ) \qquad ( 12 )$$

It is noted that QNSD solves m+n max-weight problems in each iteration, leading to a running-time per iteration of O((m−n)nL)=O(mnL). Here, recall that the number of clients scales as O(n) and L is the total number of functions and, thus, the number of commodities scales as O(nL).

The performance of the QNSD algorithm may be further understood by considering the following theorem (denoted herein as Theorem 1).

Theorem 1 may be states as: Let the input service demand λ={λᵤ^{(d,ϕ)}} be such that the fractional NSDP is feasible and the Slater condition is satisfied. Then, letting V=1/ε, the QNSD algorithm provides an O(ε) approximation to the fractional NSDP in time O(1/ε). Specifically, for all t≥T(ε), the QNSD solution {f̅ᵤᵥ^{(d,ϕ,i)},y̅ᵤᵥ} satisfies

$$\begin{matrix}{\sum }_{( u , v ) ∈ {𝔼}^{a}} {w}_{uv} {\overline{y}}_{uv} \leq {h}^{opt} + O ( ɛ ) & ( 13 ) \\ {\sum }_{v ∈ {δ}^{-} ( u )} {\overline{f}}_{vu}^{( d , φ , i )} - {\sum }_{v ∈ {δ}^{+} ( u )} {\overline{f}}_{uv}^{( d , φ , i )} \leq O ( ɛ ) ∀ u , d , φ , i & ( 14 ) \\ Eq . ( 3 ) \text{-} Eq . ( 7 ) & ( 15 )\end{matrix}$$

where h^{opt} denotes the optimal objective function value and T(ε) is an O(1/ε) function, whose expression is derived in the proof of Theorem 1 (which follows).

Let

Q(t+1)=[Q(t)+Af(t)]⁺ (16)

denote the matrix form of the QNSD queuing dynamics given by Eq. (8), where f(t), Q(t), and A denote the flow vector in iteration t, the queue-length vector in iteration t, and the matrix of flow coefficients, respectively.

Let

$$Z ( Q ) \underline{\underline{Δ}} {inf}_{[ y , f ] ∈ \times } \{ {Vw}^{†} y + {( Af )}^{†} Q \} \qquad ( 17 )$$

denote the dual function of the fractional NSDP weighted by the control parameter V, where w is the resource cost vector and X is the set of feasible solutions to the fractional NSDP.

Let H* [symbol] {Q*:Q*=argₘₐₓ_{_{Q}}Z(Q)} denote the set of all optimizers of Z(Q).

Let H_{y} [symbol] {Q:sup_{Q*∈H*}{∥Q−Q*∥}≤γ} denote the set of queue-length vectors that are at most γ-away from any point in H*. It is assumed that the value of γ is independent of the control parameter V (while this assumption is not needed to provide Theorem 1, it may be useful in the proof of Theorem 1).

Since Z(Q) is a piecewise linear concave function of Q, the locally polyhedron property is satisfied, i.e.,: ∀Q∉H_{γ} and ∀Q*∈H*, there exists a L_{γ}>0 such that

Z(Q*)−Z(Q)≥L_{γ}∥Q*−Q∥. (18)

The set of queue-length vectors that are D-away from H* is denoted as

$${H}_{D} {Δ}_{=} \{ Q \text{:} {sup}_{{Q}^{*} ∈ {H}^{*}} \{ ‖ Q - {Q}^{*} ‖ \} \leq D \} ,$$

with

$$D {Δ}_{=} max \{ \frac{B}{{L}_{γ}} - \frac{{L}_{γ}}{4} , \frac{{L}_{γ}}{2} , γ \} ,$$

where B is an upper bound for ∥Af∥² defined as

$$B {Δ}_{=} {\sum }_{u} [ {( {\sum }_{v ∈ {δ}^{-} ( u )} \frac{{c}_{vu}}{{min}_{( φ , i )} {r}_{vu}^{( φ , i )}} )}^{2} + {( {\sum }_{v ∈ {δ}^{+} ( u )} \frac{{c}_{uv}}{{min}_{( φ , i )} {r}_{uv}^{( φ , i )}} )}^{2} ] .$$

The proof of Theorem 1 may be based on proofs of a number of Lemmas, which are discussed below.

Lemma 1 Under QNSD, if Q(t)∉H_{D}, then, for all Q* ∉H*,

$$‖ Q ( t + 1 ) - {Q}^{*} ‖ \leq ‖ Q ( t ) - {Q}^{*} ‖ - \frac{{L}_{γ}}{2} .$$

A proof of Lemma 1 follows.

From Eq. (16), it follows that:

∥Q(t−1)−Q*∥²=∥[Q(t)+Af(t)]⁺−Q*∥²≤|Q(t)+Af(t)−Q*∥²≤|Q(t)−Q*∥²+B+2(Q(t)−Q*)^{†}Af(t) (19)

where Eq. (19) is due to the fact that ∥Af(t)∥²≤B , as shown in the following:

$${‖ Af ‖}^{2} = {\sum }_{u} {\sum }_{( d , φ , i )} {( {\sum }_{v ∈ {δ}^{-} ( u )} {f}_{vu}^{( d , φ , i )} - {\sum }_{v ∈ {δ}^{+} ( u )} {f}_{uv}^{( d , φ , i )} )}^{2} \leq {\sum }_{u} {\sum }_{( d , φ , i )} [ {( {\sum }_{v ∈ {δ}^{-} ( u )} {f}_{vu}^{( d , φ , i )} )}^{2} + {( {\sum }_{v ∈ {δ}^{+} ( u )} {f}_{uv}^{( d , φ , i )} )}^{2} ] \leq {\sum }_{u} [ {( {\sum }_{v ∈ {δ}^{-} ( u )} {\sum }_{( d , φ , i )} {f}_{vu}^{( d , φ , i )} )}^{2} + {( {\sum }_{v ∈ {δ}^{+} ( u )} {\sum }_{( d , φ , i )} {f}_{uv}^{( d , φ , i )} )}^{2} ] \leq {\sum }_{u} [ {( {\sum }_{v ∈ {δ}^{-} ( u )} \frac{{c}_{vu}}{{min}_{( φ , i )} {r}_{vu}^{( φ , i )}} )}^{2} + {( {\sum }_{v ∈ {δ}^{+} ( u )} \frac{{c}_{uv}}{{min}_{( φ , i )} {r}_{uv}^{( φ , i )}} )}^{2} ] {Δ}_{=} B . \qquad ( 20 )$$

From Eq. (17), it follows that, for all Q*∈H*,

$$Z ( Q ( t ) ) - Z ( {Q}^{*} ) = {inf}_{[ {y}^{′} , {f}^{′} ] ∈ X} \{ {Vw}^{†} {y}^{′} + {( {Af}^{′} )}^{†} Q ( t ) \} - {inf}_{[ {y}^{′} , {f}^{′} ] ∈ X} \{ {Vw}^{†} {y}^{′} + {( {Af}^{′} )}^{†} {Q}^{*} \} \geq {Vw}^{†} y ( t ) + {( Af ( t ) )}^{†} Q ( t ) - {Vw}^{†} y ( t ) + {( Af ( t ) )}^{†} {Q}^{*} = {( Af ( t ) )}^{†} ( Q ( t ) - {Q}^{*} ) . \qquad ( 21 )$$

Using Eq. (21) in Eq. (19), it follows that

∥Q(t−1)−Q*∥²≤∥Q(t)−Q*∥²+B−2(Z(Q*)−Z(Q(t))) (22)

From the definition of H_{D}, it may be shown that, for any Q(t)∉H_{D} and any Q*∈H*,

$$\frac{{L}_{γ}^{2}}{4} - {L}_{γ} ‖ {Q}^{*} - Q ( t ) ‖ \geq B - 2 {L}_{γ} ‖ {Q}^{*} - Q ( t ) ‖ . \qquad ( 23 )$$

Now, using Eq. (18) and Eq. (23) in Eq. (22),

$${‖ Q ( t + 1 ) - {Q}^{*} ‖}^{2} \leq {‖ Q ( t ) - {Q}^{*} ‖}^{2} + B - 2 {L}_{γ} ‖ {Q}^{*} - Q ( t ) ‖ \leq {‖ Q ( t ) - {Q}^{*} ‖}^{2} + \frac{{L}_{γ}^{2}}{4} - {L}_{γ} ‖ {Q}^{*} - Q ( t ) ‖ = {( ‖ Q ( t ) - {Q}^{*} ‖ - \frac{{L}_{γ}}{2} )}^{2} . \qquad ( 24 )$$

Hence, for any Q(t)∈H_{D}, the queue length evolution is regulated by

$$‖ Q ( t + 1 ) - {Q}^{*} ‖ \leq ‖ Q ( t ) - {Q}^{*} ‖ - \frac{{L}_{γ}}{2} . \qquad ( 25 )$$

Lemma 2: Assuming the Slater condition holds, and letting

$${R}_{D} {Δ}_{=} \{ Q \text{:} {sup}_{{Q}^{*} ∈ {H}^{*}} ‖ Q - {Q}^{*} ‖ \leq D + \sqrt{B} \} , \\ {τ}_{{R}_{D}} {Δ}_{=} inf \{ t \geq 0 \text{:} Q ( t ) ∈ {R}_{D} \} , \qquad ( 26 )$$

then, for all t≥τ_{R}_{_{D}}, Q(t)∈R_{D}. A proof of Lemma 2 follows.

The proof of Lemma 2 is based on induction. By the definition of τ_{R}_{_{D}}, it is known that Q(t)∈R_{D} for t=τ_{R}_{_{D}}. Now, assume Q(t)∈R_{D} holds in iteration t≥τ_{R}_{_{D}}. Then, in iteration t+1, the following holds: if Q(t)∉H_{D}, according to Lemma 1, then

$$\vert Q ( t + 1 ) - {Q}^{*} \vert \leq \vert Q ( t ) - {Q}^{*} \vert - \frac{{L}_{γ}}{2} \leq D + \sqrt{B} - \frac{{L}_{γ}}{2} ;$$

on other hand, if Q(τ_{R}_{_{D}})∈H_{D}, then |Q(t+1)−Q*|≤|Q(t)−Q*|+|Q(t+1)−Q(t)|≤D+\sqrt{B}. Hence, in either case, Q(t+1)∈R_{D}.

Lemma 3: Letting h^{max}=max_{y}{w^{†}y}, if the Slater condition holds, the queue-length vector of QNSD satisfies

$$‖ Q ( t ) ‖ \leq \frac{B / 2 + {Vh}^{max}}{κ} + \sqrt{B} , ∀ t > 0 , \qquad ( 27 )$$

where κ is a positive number satisfying ∥Q(t+1)∥²−∥Q(t)∥²≤B+Vh^{max}−κ∥Q(t)∥.

Starting from the queuing dynamics in Eq. (16), squaring both sides of the equality, recalling that ∥Af(t)∥²≤B, and adding Vw^{†}y(t) on both sides, after algebraic manipulation:

$$\frac{1}{2} [ {‖ Q ( t + 1 ) ‖}^{2} - {‖ Q ( t ) ‖}^{2} ] + {Vw}^{†} y ( t ) \leq \frac{B}{2} + {Vw}^{†} y ( t ) + {Q ( t )}^{†} Af ( t ) . \qquad ( 28 )$$

As described above, QNSD computes the resource and flow vectors [y(t), f(t)] in iteration t as

$$[ y ( t ) , f ( t ) ] = arg {inf}_{[ {y}^{′} , {f}^{′} ] ∈ X} \{ {Vw}^{†} {y}^{′} + {( {Af}^{′} )}^{†} Q ( t ) \} , \qquad ( 29 )$$

which implies that, for any feasible [y,f],

Vw^{†}y(t)+Q(t)^{†}(Af(t))≤Vw^{†}y+Q(t)^{†}Af. (30)

Based on the Slater condition, there exists a positive number κ and a [y,f], such that Af≤−κ1, and it follows that

Vw^{†}y(t)+Q(t)^{†}Af(t)≤Vh^{max} −κ∥Q(t)∥. (31)

Consider the following two cases:

$$If ‖ Q ( t ) ‖ \geq ( B / 2 + {Vh}^{max} ) / κ , using Eq . ( 31 ) in Eq . ( 28 ) yields \frac{1}{2} [ {‖ Q ( t + 1 ) ‖}^{2} - {‖ Q ( t ) ‖}^{2} ] \leq \frac{B}{2} + {Vh}^{max} - {Vw}^{†} y ( t ) - κ ‖ Q ( t ) ‖ \leq 0. \\ If ‖ Q ( t ) ‖ < ( B / 2 + {Vh}^{max} ) / κ , then \\ ‖ Q ( t + 1 ) ‖ \leq ‖ Q ( t ) ‖ + ‖ Af ( t ) ‖ \leq \frac{B / 2 + {Vh}^{max}}{κ} + \sqrt{B} . \qquad ( 32 )$$

Hence, in either case, ∥Q(t)∥ can be upper bounded by (B/2+Vh^{max})/κ+\sqrt{B} for all t>0.

The proof of Theorem 1 follows. Using Eq. (30) and evaluating the right-hand side of Eq. (28) at the optimal solution [y^{opt},f^{opt}] gives

$$\frac{1}{2} ( {‖ Q ( t + 1 ) ‖}^{2} - {‖ Q ( t ) ‖}^{2} ) + {Vw}^{†} y , \\ \leq \frac{B}{2} + {Vw}^{†} {y}^{opt} + {Q ( t )}^{†} {AF}^{opt} ( t ) , and \\ = \frac{B}{2} + {Vw}^{†} {y}^{opt} , \qquad ( 34 )$$

where the last equality follows from Af^{opt}(t)=0 . Now, denoting h^{opt}=w⁵⁵⁴ y^{opt}, from Eq. (34), it follows that

$${w}^{†} y ( t ) - {h}^{opt} \leq \frac{B}{2 V} - \frac{1}{2 V} ( {‖ Q ( t + 1 ) ‖}^{2} - {‖ Q ( t ) ‖}^{2} ) . \qquad ( 35 )$$

Next, taking the average of Eq. (35) over the j-th iteration frame [tⱼ, tⱼ+Δₜ_{ⱼ}]gives:

$$\frac{1}{{Δ}_{{t}_{j}} + 1} {\sum }_{τ = {t}_{j}}^{{t}_{j} + {Δ}_{{t}_{j }}} {w}^{†} y ( τ ) - {h}^{opt} \leq \frac{B}{2 V} + \frac{( {‖ Q ( {t}_{j} ) ‖}^{2} - {‖ Q ( {t}_{j} + {Δ}_{{t}_{j}} ) ‖}^{2} )}{2 V ( {Δ}_{{t}_{j}} + 1 )} .$$

Next, the following two properties are used:

R1: τ_{R}_{_{D}}=O(h^{max}V/L_{γ}κ)=O(mV).

R2: if tⱼ≥τ_{R}_{_{D}} then

∥Q(tⱼ)∥²−∥Q(tⱼ+Δₜ_{ⱼ})∥²=O((D+\sqrt{B})h^{max}V/L_{δ}κ)=O(m²V).

In order to prove R1, according to Lemma 1:

τ_{R}_{_{D}}≤|2∥Q*−Q(0)∥/L_{γ}|=|2∥Q*∥/L_{γ}|.

Additionally, from Lemma 3, it is noted that

$$‖ {Q}^{*} ‖ \leq ‖ Q ( {τ}_{{R}_{D}} ) ‖ + ‖ {Q}^{*} - Q ( {τ}_{{R}_{D}} ) ‖ \leq \frac{B / 2 + {Vh}^{max}}{κ} + \sqrt{B} + D . \qquad ( 36 )$$

Hence, it follows that

$${τ}_{{R}_{D}} \leq ⌈ \frac{2}{{L}_{γ}} ( \frac{B / 2 + {Vh}^{max}}{κ} + \sqrt{B} + D ) ⌉ , \qquad ( 37 )$$

and, therefore, τ_{R}_{_{D}} may be written as

$${τ}_{{R}_{D}} = O ( \frac{{h}^{max} V}{{L}_{γ} κ} ) = O ( mV ) . \qquad ( 38 )$$

The above relation holds true because h^{max}≤mh₀^{max}=O(m), where h₀^{max} is the maximum per-node-cost.

In order to prove R2, according to Lemma 2, if tⱼ≥τ_{R}_{_{D}}, by using Eq. (37), then it follows that

$${‖ Q ( {t}_{j} ) ‖}^{2} - {‖ Q ( {t}_{j} + {Δ}_{{t}_{j}} ) ‖}^{2} = {‖ Q ( {t}_{j} ) - {Q}^{*} ‖}^{2} - {‖ Q ( {t}_{j} + {Δ}_{{t}_{j}} ) - {Q}^{*} ‖}^{2} + 2 {Q}^{* †} [ Q ( {t}_{j} ) - Q ( {t}_{j} + {Δ}_{j} ) ] \leq {‖ Q ( {t}_{j} ) - {Q}^{*} ‖}^{2} + 2 ‖ {Q}^{*} ‖ \cdot ‖ Q ( {t}_{j} ) - Q ( {t}_{j} + {Δ}_{j} ) ‖ \leq {( D + \sqrt{B} )}^{2} + 2 ‖ {Q}^{*} ‖ ( D + \sqrt{B} ) = O ( \frac{( D + \sqrt{B} ) {h}^{max} V}{κ} ) = O ( {m}^{2} V ) , \qquad ( 39 )$$

where the last equality is due to h^{max}=O(m), D=O(B), and

$$B \leq 2 {\sum }_{u} [ {\sum }_{v ∈ {δ}^{-} ( u )} {( \frac{{c}_{vu}}{{min}_{( φ , i )} {r}_{vu}^{( φ , i )}} )}^{2} + {\sum }_{v ∈ {δ}^{+} ( u )} {( \frac{{c}_{uv}}{{min}_{( φ , i )} {r}_{uv}^{( φ , i )}} )}^{2} ] \leq 2 m {max}_{( u , v ) ∈ {E}^{a}} \frac{{c}_{uv}^{2}}{{min}_{( φ , i )} {( {r}_{uv}^{( φ , i )} )}^{2}} = O ( m ) . \qquad ( 40 )$$

Using R1 and R2, and letting V=1/ε and Δᵢ_{ⱼ}≥┌mV−1┐, it follows from Eq. (35) that, for all tⱼ≥τ_{R}_{_{D}},

$${w}^{†} ( {\sum }_{τ = {t}_{j}}^{{t}_{j} + {Δ}_{{t}_{j}}} \frac{y ( τ )}{{Δ}_{{t}_{j}} + 1} ) - {h}^{opt} \leq \frac{B}{2 V} + \frac{{h}^{max} ( D + \sqrt{B} )}{κ ( {Δ}_{j} + 1 )} + \frac{3 {κ ( D + \sqrt{B} )}^{2} + B ( D + \sqrt{B} )}{2 κ V ( {Δ}_{j} + 1 )} = O ( \frac{B}{2 V} + \frac{{h}^{max} ( D + \sqrt{B} )}{m κ V} ) = O ( \frac{m}{V} ) = O ( m ɛ ) . \qquad ( 41 )$$

Observing that

$${\overline{y}}_{uv} = {\sum }_{τ = {t}_{j}}^{{t}_{j} + {Δ}_{{t}_{j}}} \frac{{y}_{uv} ( τ )}{{Δ}_{{t}_{j}} + 1} ,$$

Eq. (13) in Theorem 1 follows. In order to prove Eq. (14), starting from Eq. (16), it follows that

Q(t+1)≥Q(t)+Af(t), (42)

from which it follows that, for all tⱼ≥τ_{R}_{_{D}},

$${\sum }_{τ = {t}_{j}}^{{t}_{j} + {Δ}_{{t}_{j}}} \frac{Af ( t )}{{Δ}_{{t}_{j}} + 1} \leq \frac{Q ( {t}_{j} + {Δ}_{{t}_{j}} ) - Q ( {t}_{j} )}{{Δ}_{{t}_{j}} + 1} . \qquad ( 43 )$$

Finally, the {u,(d,ϕ,i)}-th element of the vectors in Eq. (43) satisfies

$${\sum }_{v ∈ {δ}^{-} ( u )} {\overline{f}}_{vu}^{( d , φ , i )} - {\sum }_{v ∈ {δ}^{+} ( u )} {\overline{f}}_{uv}^{( d , φ , i )} \leq \frac{\vert {Q}_{u}^{( d , φ , i )} ( {t}_{j} + {Δ}_{{t}_{j}} ) - {Q}_{u}^{*} \vert + \vert {Q}_{u}^{( d , φ , i )} ( {t}_{j} ) - {Q}_{u}^{*} \vert}{{Δ}_{{t}_{j}} + 1} \leq \frac{2 ( D + \sqrt{B} )}{mV} = O ( \frac{1}{V} ) = O ( ɛ ) , \\ where \\ {\overline{f}}_{vu}^{( d , φ , i )} = {\sum }_{τ = {t}_{j}}^{{t}_{j} + {Δ}_{{t}_{j}}} \frac{{f}_{vu}^{( d , φ , i )} ( τ )}{{Δ}_{{t}_{j}} + 1} , {\overline{f}}_{uv}^{( d , φ , i )} = {\sum }_{τ = {t}_{j}}^{{t}_{j} + {Δ}_{{t}_{j}}} \frac{{f}_{uv}^{( d , φ , i )} ( τ )}{{Δ}_{{t}_{j}} + 1} . \qquad ( 44 )$$

Note that τ_{R}_{_{D}}=O(mV)=O(m/ε) due to Eq. (38), and Δₜ_{ⱼ}≥┌mV−1┐=O(m/ε). Thus, from Eq. (41) and Eq. (44), ∀t≥T(ε) [symbol] tᵢ+Δₜ_{ⱼ}+1≥τ_{R}_{_{D}}+mV=O(m/ε), the following relations hold:

$$\begin{matrix}{\sum }_{( u , v ) ∈ {E}^{a}} {w}_{uv} {\overline{y}}_{uv} \leq {h}^{opt} + O ( m ɛ ) & ( 45 ) \\ {\sum }_{v ∈ {δ}^{-} ( u )} {\overline{f}}_{vu}^{( d , φ , i )} - {\sum }_{v ∈ {δ}^{+} ( u )} {\overline{f}}_{uv}^{( d , φ , i )} \leq O ( ɛ ) ∀ u , d , φ , i & ( 46 )\end{matrix}$$

Note that, since QNSD chooses the j-th iteration frame as j=└log₂t┘, t=2^{j}, and Δₜ_{ⱼ}=2^{j}, there exists a j* such that 2^{j}*∈[max{τ_{R}_{_{D}},mV+1},2 max{τ_{R}_{_{D}},mV+1}), and hence Eq. (45) and Eq. (46) hold.

In addition, since fᵤᵥ^{(d,ϕ,i)}(t) and yᵤᵥ(t) satisfy Eq. (3) to Eq. (7) in each iteration of QNSD, so does the final solution {f̅ᵤᵥ^{(d,ϕ,i)},y̅ᵤᵥ}, which concludes the proof of Theorem 1.

It is noted that, while the claim of Theorem 1 does not specify the dependence of the approximation on the size of the cloud network (m,n), it may be shown that, in time O(m/ε), the total cost approximation is O(mε) and the flow conservation violation is O(ε). The total running time of QNSD is then O(ε⁻¹m²nL).

As noted above, it has been conjectured that, with a properly chosen θ∈[0,1), QNSD provides an O(ε) approximation to the fractional NSDP in time O(1/\sqrt{ε}). This conjecture is based on the fact that: i) as shown in the proof of Theorem 1, θ=0 is sufficient for QNSD to achieve O(1/ε) convergence, ii) it may be shown that there is O(1/\sqrt{ε}) convergence of queue-length based algorithms for stochastic optimization when including a first-order memory or momentum of the differential queue backlog, and iii) simulation results (discussed further below) show a significant improvement in the running time of QNSD with nonzero θ.

Various embodiments of the distributed cloud networking capability may be configured to support integer NSDP.

It may be shown, by reduction from MCND, that the integer NSDP is NP-Hard. Recall that the integer NSDP is equivalent to MCND for the special case of single-commodity services. Hence, no O(ε) approximation can, in general, be computed in sub-exponential time. After recognizing the difficulty of approximating the integer NSDP, it is possible to establish key observations on the behavior of QNSD that allows the addition of a simple, yet effective, condition on the evolution of QNSD that enables constructing a solution to the integer NSDP of good practical performance.

It may be observed that the QNSD algorithm evolves by allocating an integer number of resources in each iteration. In fact, QNSD solves a max-weight problem in each iteration and allocates either zero or the maximum number of resource units to a single commodity at each cloud network location. However, the solution in each iteration may significantly violate flow conservation constraints. On the other hand, the average over the iterations is shown to converge to a feasible, but, in general, fractional solution. Based on these observations, constrained QNSD (C-QNSD) is proposed. C-QNSD is a variation of QNSD designed to constrain the solution over the algorithm iterations to satisfy flow conservation across consecutive iterations, such that when the iterative flow solution converges, a feasible solution to the integer NSDP may be guaranteed. C-QNSD works just as QNSD, but with the max-weight problems solved in each iteration replaced by the fractional knapsak problems that result from adding the conditional flow conservation constraints:

$${\sum }_{v ∈ {δ}^{+} ( u )} {f}_{uv}^{( d , φ , i )} ( t ) \leq {\sum }_{v ∈ {δ}^{-} ( u )} {f}_{vu}^{( d , φ , i )} ( t - 1 ) ∀ d , φ , i .$$

Specifically, in each iteration of the main procedure, after the queue updates described by Eq. (8) to Eq. (10), the transport and processing decisions are jointly determined as follows:

Transport and processing decisions: For each u∈V:

$$max {\sum }_{v ∈ {δ}^{+} ( u )} {\sum }_{( d , φ , i )} {W}_{uv}^{( d , φ , i )} {f}_{uv}^{( d , φ , i )} ( t ) - {Vy}_{uv} ( t ) {w}_{uv}$$

$$s . t . ( 16 ) , ( 16 ) ( 4 ) , ( 16 ) ( 4 ) ( 7 )$$

$$where$$

$${W}_{uv}^{( d , φ , i )} ( t ) = \frac{1}{{r}_{uv}^{tr}} ( {U}_{u}^{( d , φ , i )} ( t ) - {U}_{v}^{( d , φ , i )} ( t ) )$$

$$∀ v ∈ {δ}^{+} ( u ) \backslash \{ p ( u ) \}$$

$${W}_{u , p ( u )}^{( d , φ , i )} ( t ) = \frac{1}{{r}_{u}^{( φ , i + 1 )}} ( {U}_{u}^{( d , φ , i )} ( t ) - {U}_{u}^{( d , φ , i + 1 )} ( t ) )$$

It may be observed that, without the conditional flow conservation constraints, the problem above can be decoupled into the set of max-weight problems whose solutions drive the resource allocation and flow rate assignment of QNSD. When including the conditional flow conservation constraints, the solution to the above maximization problem is forced to fill-up the cloud network resource units with multiple commodities, smoothing the evolution towards a feasible integer solution. In C-QNSD, the above maximization problem is solved via a linear-time heuristic that decouples the problem into a set of fractional knapsacks, one for each neighbor node v∈δ⁺(u) and resource allocation choice yᵤᵥ∈{0,1, . . . ,cᵤᵥ}. As shown below, C-QNSD effectively consolidates service flows into a limited number of active resources.

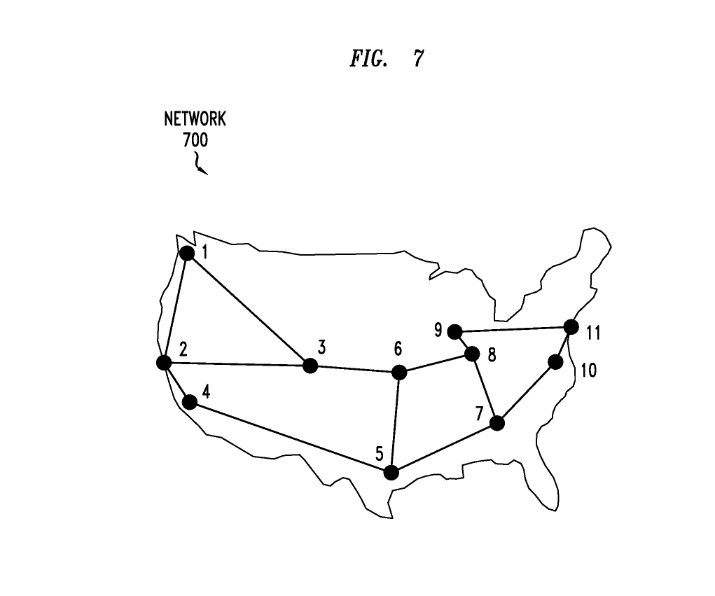

Various embodiments of QNSD and C-QNSD may be further understood based on an evaluation of the performance of QNSD and C-QNSD within the context of an Abilene US continental network composed of 11 nodes and 28 directed links, as illustrated in FIG. 7. Here, it is assumed that each node and link is equipped with 10 cloud resource units and 10 network resource units, respectively. The cost per cloud resource unit is set to 1 at nodes 5 and 6, and to 3 at all other nodes. The cost per network resource unit is set to 1 for all 28 links.

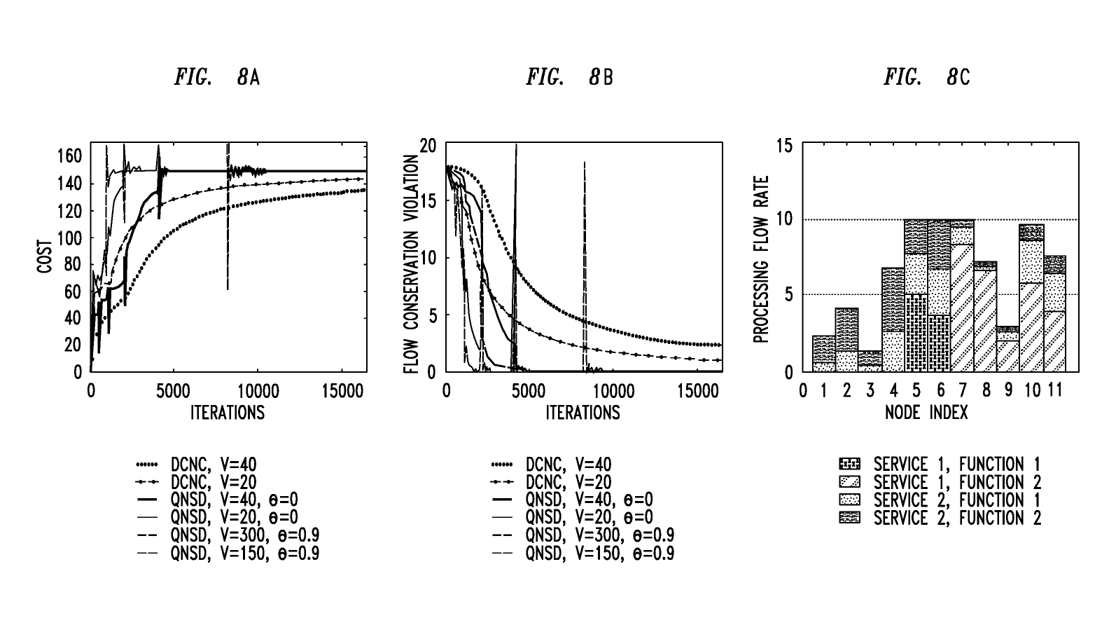

In order to test the performance of QNSD, consider a scenario with 2 services, each composed of 2 functions. Function (1,1) (service 1, function 1) has resource requirement 1 resource unit per flow unit, while functions (1,2), (2,1), and (2,2) require 3, 2, and 2 resource units per flow unit, respectively. It is assumed that resource requirements do not change across cloud locations, and that all links require 1 network resource unit per flow unit. There are 6 clients, represented by destination nodes {1,2,4,7,10,11} in FIG. 7. Each destination node in the west coast {1,2,4} has each of the east coast nodes {11,10,7} as source nodes, and vice versa, thereby resulting in a total of 18 source-destination pairs. It is assumed that each east coast client requests service 1 and each west coast client requests service 2, and that all input flows have size 1 flow unit. The results are depicted in FIGS. 8A-8C. FIG. 8A depicts the evolution of the cost function over the algorithm iterations. Recall that various embodiments of QNSD may exhibit the following features: queue-length driven, truncated average computation, and first-order memory. In FIGS. 8A-8C, QNSD without truncation and without memory is referred to as DCNC (as it resembles the evolution of the dynamic cloud network control algorithm), QNSD with θ=0 refers to as QNSD with truncation but without memory, and finally, QNSD with θ>0 refers to the QNSD algorithm with both truncation and memory. FIGS. 8A-8C illustrate the improved convergence obtained when progressively including the three key features of QNSD. For example, it may be observed that DCNC evolves the slowest and it is not able to reach the optimal objective function value within the 16000 iterations shown. Decreasing the control parameter V from 40 to 20 speeds up the convergence of DCNC, but yields a further-from-optimal approximation, not appreciated in the plot due to the slow convergence of DCNC. In fact, QNSD without truncation and memory can only guarantee a O(1/ε²) convergence. On the other hand, when including truncation, QNSD is able to reach the optimal cost value of 149 in around 6000 iterations, clearly illustrating the faster O(1/ε) convergence. The peaks exhibited by the curves of QNSD with truncation illustrate the reset of the average computations at the beginning of each iteration frame. Note again that reducing V further speeds up convergence at the expense of slightly increasing the optimality gap. Finally, when including the memory feature with a value of θ=0.9, QNSD is able to converge to the optimal solution even faster, illustrating the conjectured O(1/\sqrt{ε}) speed-up from the momentum generated when combining gradient directions. Decreasing V again illustrates the speed-up versus optimality tradeoff. FIG. 8B shows the convergence of the violation of the flow conservation constraints and a similar behavior may be observed as in the cost convergence, with significant speed-ups when progressively adding truncation and memory to QNSD. Finally, FIG. 8C shows the processing resource allocation distribution across cloud network nodes. As depicted in FIG. 8C, most of the flow processing concentrates on the cheapest nodes 5 and 6. For example, note how function (1,1), which has the lowest processing requirement (namely, 1 resource unit per flow unit) gets exclusively implemented in nodes 5 and 6, as it gets higher priority in the scheduling decision of QNSD. Functions (2,1) and (2,2), which require 2 resource units per flow unit, share the remaining processing capacity at nodes 5 and 6. Finally, function (1,2), with resource requirement 3 resource units per flow unit, and following function (1,1) in the service chain, gets distributed closer to the east coast nodes, destinations for service 1.

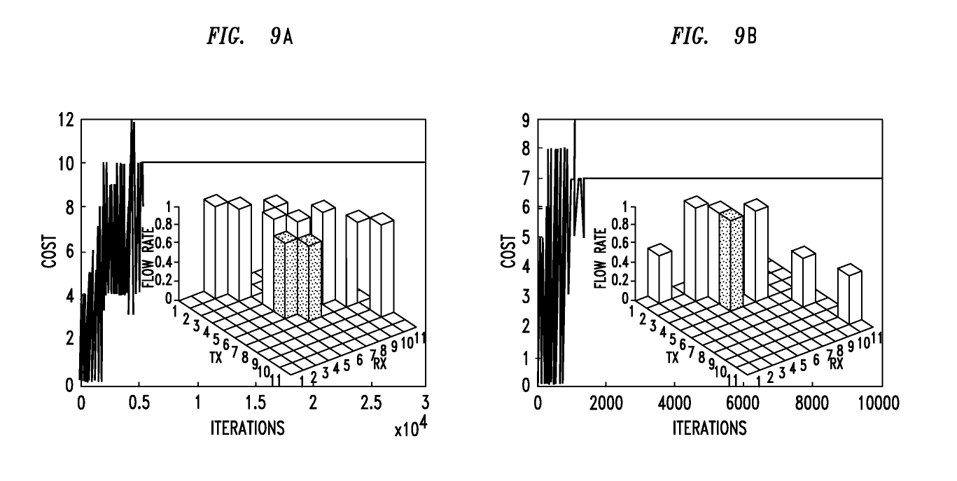

In order to test the performance of C-QNSD, consider a scenario with 2 s-d pairs, (1,11) and (2,7), both requesting one service composed of one function with resource requirement 1 cloud resource per flow unit. The performance of C-QNSD is simulated for input rates 1 flow unit and 0.5 flow unit per client. The results are depicted in FIGS. 9A-9B. FIG. 9A depicts that, for input rate 1, C-QNSD is able to converge to a solution of total cost 10, in which each client flow follows the shortest path and where the flow processing happens at nodes 5 and 6, respectively. The 3D bar plot shows the flow distribution over the links (non-diagonal entries in blue) and nodes (diagonal entries in red) in the network. FIG. 9B depicts that, for input rate 1, the flow of s-d pair (1,11) is now routed along the longer path {1,2,4,5,7,10,11} in order to consolidate as much flow as possible on the activated resources for s-d pair (2,7). The flow processing of both services is now consolidated at node 5, yielding an overall cost of 7, which is the optimal solution to the integer NSDP in this setting. It is noted that, if the two client flows were following the shortest path and separately getting processed at nodes 5 and 6, without exploiting the available resource consolidation opportunities, the total cost under integer resources would be 10. From these results, it may be seen that the combined use of momentum information and conditional flow conservation constraints may be used to provide efficient solutions to the integer NSDP in practical network settings.

It will be appreciated that, although omitted for purposes of clarity, various embodiments of the model and algorithms presented herein may be extended in various ways.

In at least some embodiments, for example, various embodiments of the model and algorithms presented herein may be extended by controlling function availability. For example, function availability may be controlled by limiting the availability of certain service functions to a subset of cloud nodes can be modeled by setting the flow variables associated with function (ϕ,i) to zero, f_{p(u),u}^{(d,ϕ,i)}=0, for all d and for all cloud nodes u in which function (ϕ,i) is not available.

In at least some embodiments, for example, various embodiments of the model and algorithms presented herein may be extended by controlling function flow scaling. For example, function flow scaling may be controlled by capturing the fact that flows can change size as they go through certain functions, which can be modeled by letting ξ^{(ϕ,i}) denote the number of output flow units per input flow unit of function (ϕ,i)and modifying the service chaining constraints (3) as ξ^{(ϕ,i)}f_{p(u),u}^{(d,ϕ,i)}=f_{u,p(u)}^{(d,ϕ,i-1)}.

In at least some embodiments, for example, various embodiments of the model and algorithms presented herein may be extended by controlling per-function resource costs. For example, if the cost function depends on the number of virtual resource units (e.g., VMs) instead of on the number of physical resource units (e.g., servers), then yᵤᵥ^{(ϕ,i)} and wᵤᵥ^{(ϕ,i)} may be used to denote the number of allocated resource units of service function (ϕ,i) and the cost per resource unit of service function (ϕ,i), respectively.

In at least some embodiments, for example, various embodiments of the model and algorithms presented herein may be extended by using non-linear cost functions. For example, in order to capture nonlinear cost effects such as economies of scale in which the cost per resource unit decreases with the number of allocated resource units, the cost function can be modified as Σᵤᵥy_{uv,k}w_{uv,k}, with y_{uv,k}∈{0,1} indicating the allocation of k resource units, and w_{uv,k} denoting the cost associated with the allocation of k resource units. The capacity constraints in Eq. (4) become Σ_{(d,ϕ,i)}fᵤᵥ^{(d,ϕ,i)}rᵤᵥ^{(ϕ,i+1)}≤ky_{uv,k}≤cᵤᵥ.

It will be appreciated that, although primarily presented herein with respect to embodiments supporting distributed cloud networking for network services within a cloud environment, various embodiments presented herein may be used or adapted to support distribution of other types of services within a cloud environment. For example, various embodiments presented herein may be used or adapted to support distribution of cloud services, distribution of other types of services not traditionally hosted within the cloud, distribution of newly identified cloud services not currently supported within the cloud, or the like, as well as various combinations thereof. For example, various embodiments presented herein may be used or adapted to support distribution of any services which may be provided using a chain of functions (e.g., augmented reality, immersive video, real-time computer vision, tactile internet, or the like).

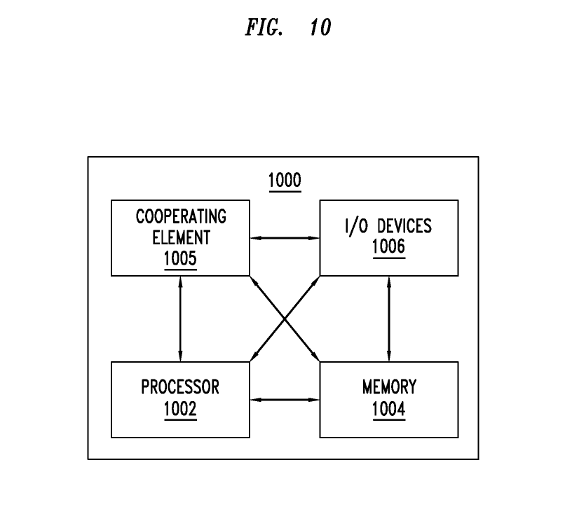

FIG. 10 depicts a high-level block diagram of a computer suitable for use in performing functions described herein.

The computer 1000 includes a processor 1002 (e.g., a central processing unit (CPU) and/or other suitable processor(s)) and a memory 1004 (e.g., random access memory (RAM), read only memory (ROM), and the like). The computer 1000 also may include a cooperating module/process 1005. The cooperating process 1005 can be loaded into memory 1004 and executed by the processor 1002 to implement functions as discussed herein and, thus, cooperating process 1005 (including associated data structures) can be stored on a computer readable storage medium, e.g., RAM memory, magnetic or optical drive or diskette, and the like.

The computer 1000 also may include one or more input/output devices 1006 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 1000 depicted in FIG. 10 provides a general architecture and functionality suitable for implementing functional elements described herein and/or portions of functional elements described herein. For example, the computer 1000 provides a general architecture and functionality suitable for implementing one or more of an element of a DDC 110, a portion of an element of a DDC 110, an element of CN 120, a portion of an element of CN 120, a CD 130, a portion of a CD 130, CSMS 140, a portion of CSMS 140, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that at least some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
determine a set of commodities for a service to be hosted within a cloud network for a set of client demands, the service comprising a set of service functions, the cloud network comprising a set of cloud nodes and a set of network links;
at each of a plurality of iterations:
update, for each of the commodities at each of the cloud nodes based on the client demands, a respective set of queue variables for the respective commodity at the respective cloud node; and
determine, based on the sets of queue variables of the respective commodities at the respective cloud nodes, a respective set of solution variables for the respective iteration; and
determine, based on the respective sets of solution variables of at least a portion of the iterations, a service distribution solution for the service within the cloud network that is configured to satisfy the set of client demands.

2. The apparatus of claim 1, wherein, to determine the set of commodities, the processor is configured to:
determine the set of commodities based on the set of client demands and based on a service graph description of a service graph of the service.

3. The apparatus of claim 1, wherein the service functions of the service are organized as a chain.

4. The apparatus of claim 1, wherein the cloud nodes represent distributed cloud locations at which the service functions can be instantiated, wherein the network links represent network connections between cloud locations.

5. The apparatus of claim 1, wherein the processor is configured to:
define, for the cloud network, a cloud network queuing system comprising the respective sets of queue variables for the respective commodities at the respective cloud nodes.

6. The apparatus of claim 1, wherein the respective set of queue variables comprises an actual queue variable configured to be updated based on actual queuing dynamics of the respective commodity at the respective cloud node.

7. The apparatus of claim 1, wherein the respective set of queue variables comprises a virtual queue variable configured to be updated based on a combination of actual queueing dynamics of the respective commodity at the respective cloud node and a differential queue backlog of the respective commodity at the respective cloud node over multiple iterations.

8. The apparatus of claim 1, wherein the respective set of solution variables for the respective iteration comprises a set of resource allocation variables.

9. The apparatus of claim 8, wherein, to determine the set of resource allocation variables, the processor is configured to:
for each of the network links, select one of the commodities to transmit over the respective network link and allocate network resources on the respective network link for the selected one of the commodities; and
for each of the cloud nodes, select one of the commodities to be processed at the respective cloud node and allocate cloud resources on the respective cloud node for the selected one of the commodities.

10. The apparatus of claim 9, wherein, to select the one of the commodities to transmit over the respective network link, the processor is configured to:
compute, for each of the commodities based on the respective sets of queue variables of the respective commodities, a respective transport utility weight of transmitting the respective commodity on the respective network link; and
select the one of the commodities having a maximum respective transport utility weight.

11. The apparatus of claim 9, wherein, to allocate network resources on the respective network link for the selected one of the commodities, the processor is configured to:
allocate network resources on the respective network link for the selected one of the commodities based on a capacity of the respective network link.

12. The apparatus of claim 9, wherein, to select one of the commodities to be processed at the respective cloud node, the processor is configured to:
compute, for each of the commodities based on the respective sets of queue variables of the respective commodities, a respective processing utility weight of processing the commodity at the cloud node; and
select the one of the commodities having a maximum respective processing utility weight.

13. The apparatus of claim 9, wherein, to allocate cloud resources on the respective cloud node for the selected one of the commodities, the processor is configured to:
allocate cloud resources on the respective cloud node for the selected one of the commodities based on a capacity of an edge between the respective cloud node and a respective processing node of a cloud-augmented graph including the cloud nodes.

14. The apparatus of claim 1, wherein the respective set of solution variables for the respective iteration comprises a set of flow variables.

15. The apparatus of claim 14, wherein, to determine the set of flow variables, the processor is configured to:
for each of the network links, select one of the commodities to transmit over the respective network link and assign respective flow rates for the commodities on the respective network link based on the selected one of the commodities; and
for each of the cloud nodes, select one of the commodities to be processed at the respective cloud node and assign respective flow rates for the commodities based on the selected one of the commodities.

16. The apparatus of claim 15, wherein, to select the one of the commodities to transmit over the respective network link, the processor is configured to:
compute, for each of the commodities based on the respective sets of queue variables of the respective commodities, a respective transport utility weight of transmitting the respective commodity on the respective network link; and
select the one of the commodities having a maximum respective transport utility weight.

17. The apparatus of claim 15, wherein, to assign respective flow rates for the commodities on the respective network link based on the selected one of the commodities, the processor is configured to:
assign the respective flow rate for the selected one of the commodities based on the network resources allocated on the respective network link for the selected one of the commodities and based on a per-function resource requirement for the respective network link.

18. The apparatus of claim 15, wherein, to select one of the commodities to be processed at the respective cloud node, the processor is configured to:
compute, for each of the commodities based on the respective sets of queue variables of the respective commodities, a respective processing utility weight of processing the commodity at the cloud node; and
select the one of the commodities having a maximum respective processing utility weight.

19. The apparatus of claim 15, wherein, to assign the respective flow rates for the commodities based on the selected one of the commodities, the processor is configured to:
assign the respective flow rate for the selected one of the commodities based on the cloud resources allocated on the respective cloud node for the selected one of the commodities and based on a per-function resource requirement for the respective cloud node.

20. The apparatus of claim 1, wherein the respective set of solution variables for the respective iteration comprises a set of resource allocation variables and a set of flow variables.

21. The apparatus of claim 20, wherein, to determine the respective set of solution variables of the respective iteration, the processor is configured to:
determine a set of resource allocation variables based on the sets of queue variables of the respective commodities at the respective cloud nodes; and
determine a set of flow variables based on the set of resource allocation variables.

22. The apparatus of claim 20, wherein, to determine the respective set of solution variables of the respective iteration, the processor is configured to:
determine, jointly based on the sets of queue variables of the respective commodities at the respective cloud nodes, a set of resource allocation variables and a set of flow variables.

23. The apparatus of claim 1, wherein, to determine the service distribution solution, the processor is configured to:
compute an average of the set of solution variables over each of the iterations in the plurality of iterations.

24. The apparatus of claim 1, wherein, to determine the service distribution solution, the processor is configured to:
compute an average of the set of solution variables over a subset of the iterations in the plurality of iterations.

25. The apparatus of claim 24, wherein the processor is configured to:
determine a number of iterations in the subset of iterations over which the average is computed.

26. A method, comprising:
determining, by a processor, a set of commodities for a service to be hosted within a cloud network for a set of client demands, the service comprising a set of service functions, the cloud network comprising a set of cloud nodes and a set of network links;
at each of a plurality of iterations:
updating, by the processor for each of the commodities at each of the cloud nodes based on the client demands, a respective set of queue variables for the respective commodity at the respective cloud node; and
determining, by the processor based on the sets of queue variables of the respective commodities at the respective cloud nodes, a respective set of solution variables for the respective iteration; and
determining, by the processor based on the respective sets of solution variables of at least a portion of the iterations, a service distribution solution for the service within the cloud network that is configured to satisfy the set of client demands.

27. An apparatus, comprising:
a processor and a memory communicatively connected to the processor, the processor configured to:
determine a set of commodities for a service to be hosted within a cloud network for a set of client demands, the service comprising a set of service functions, the cloud network comprising a set of cloud nodes and a set of network links;
define, for the cloud network based on a network graph of the cloud network, a cloud-augmented graph configured to track transport and processing of flows of the commodities at the cloud nodes;
define, for the cloud network, a cloud network queuing system comprising, for each of the commodities at each of the cloud nodes, a respective set of queue variables for the respective commodity at the respective cloud node; and
determine, based on the cloud-augmented graph and the cloud network queuing system, a service distribution solution for the service within the cloud network that is configured to satisfy the set of client demands.
